(19) United States
(12) Patent Application Publication
(10) Pub. No.: US 2009/0029055 A1
(43) Pub. Date: Jan. 29, 2009

(54) Coated shaped detergent or cleaning agent body

(76) Inventor: Thomas Holderbaum, Hilden (DE)

Correspondence Address: PAUL & PAUL, 2000 MARKET STREET, Suite 2900, PHILADELPHIA, PA, 19103-3229, US

(21) Appl. No.: 11/709,043

(22) Filed: Feb. 21, 2007

Related U.S. Application Data
(63) Continuation of application No. PCT/EP05/08180, filed on Jul. 28, 2005.

(30) Foreign Application Priority Data
Aug. 20, 2004 (DE) 10 2004 040 330.9

(51) Int. Cl. B05D 3/00; B05D 1/02; C08J 7/04

(52) U.S. Cl. 427/372.2; 427/331; 427/421.1; 428/341; 428/342

(57) ABSTRACT

Methods for manufacturing a washing- or cleaning-agent shaped element, encompassing the steps of a) making available a shaped element that comprises a cavity in the form of a recess or a passthrough hole, b) applying a coating agent onto the surface of the shaped element so that the surface coverage of the coated shaped-element surface with the coating agent is between 0.2 and 50 mg/cm², are suitable for the manufacture of washing- or cleaning-agent shaped elements having excellent hardness and good solubility.

### CROSS-REFERENCE TO RELATED APPLICATIONS

This application claims priority under 35 U.S.C. § 365 and 35 U.S.C. § 120 of International Application No. PCT/EP2005/008180 filed Jul. 28, 2005. This application also claims priority under 35 U.S.C. § 119 of German Application No. DE 10 2004 040 330.9, Filed Aug. 20, 2004. Each application is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to coated shaped washing- or cleaning-agent elements and to method for the manufacture thereof. In particular, the present invention relates to shaped elements that comprise a cavity in the form of a recess or a passthrough hole, and whose surface coverage of the coated shaped-element surface with the coating agent is between 0.2 and 50 mg/cm².

(2) Description of Related Art, Including Information Disclosed Under 37 C.F.R. §§ 1.97 and 1.98.

Washing or cleaning agents are obtainable by consumers today in a wide variety of presentation forms. In addition to washing powders and granules, these forms also encompass, for example, cleaning-agent concentrates in the form of extruded or tabletted compositions. These solid, concentrated, or compressed presentation forms are notable for a reduced volume per dispensed unit, and, therefore, decrease costs for packaging and transport. The washing- or cleaning-agent tablets, in particular, additionally meet the consumer's desire for simple dispensing. The corresponding agents are comprehensively described in the existing art.

Because their constituents are greatly compressed, however, tabletted washing or cleaning agents are more difficult to dissolve than conventional powdered or liquid washing or cleaning agents.

This can cause problems. The delayed disintegration/dissolution of the constituents can result in diminished cleaning performance, incomplete dispensing of the agents through the bleach dispenser, and the formation of spots and incrustations.

Although washing- and cleaning-agent shaped elements that have sufficient fracture stability, i.e., are hard, can be manufactured, they nevertheless often cannot withstand loads during packaging, transport, and handling, se., dropping and rubbing stresses, so that edge-breakage and abrasion phenomena impair the appearance of the shaped element or in fact result in complete destruction of the shaped-element structure.

Despite the numerous publications in the field of washing or cleaning agents a need still exists for improvement in the cleaning performance of these agents, in particular, while retaining or decreasing the quantities of substances having washing or cleaning activity that are used for each washing or cleaning operation.

In the context of discussions of environmental protection and economization of resources, a need furthermore exists to reduce the quantity of materials having no washing or cleaning activity (e.g., water-soluble or non-water-soluble polymer films of the outer packaging) used to package and prepare these agents. Many suggested solutions have been developed in the existing art to resolve the dichotomy between hardness (i.e., transport and handling stability) and easy disintegration of the shaped elements. One approach that is known, in particular, from pharmaceuticals and has been extended to the field of washing- and cleaning-agent shaped elements is the incorporation of specific disintegration adjuvants that facilitate the entry of water or, upon the entry of water, swell up or act in gas-developing or otherwise disintegrating fashion. Other proposed solutions from the patent literature describe the compaction of premixes having specific particle sizes, the separation of individual ingredients from certain other ingredients, and the coating of individual ingredients or the entire shaped element with binders.

The coating of washing- and cleaning-agent shaped elements is the subject of several patent applications.

For example, European Patent Applications EP 846 754 A1, EP 846 755 A1, and EP 846 756 A1 (Proctor & Gamble) describe coated washing-agent tablets that encompass a “core” made of compressed particulate washing and cleaning agent, and a “coating,” the coating materials used being dicarboxylic acids, in particular, adipic acid, that optionally contain further ingredients such as, for example, disintegration adjuvants.

Coated washing-agent tablets are also the subject matter of European Patent Application EP 716 144 A2 (Unilever). According to the information in this document, the hardness of the tablets can be increased by a “coating” without negatively affecting disintegration and dissolution times. Film-forming substances, in particular, copolymers of acrylic acid and maleic acid or sugar, and polyethylene glycols, are cited as coating agents.

The suggested solutions disclosed in the existing art use coating materials that in some cases are only sluggishly soluble in the subsequent washing or cleaning operation, some of which materials must in fact be made capable of any disintegration at all by the addition of disintegration adjuvants. Thus, either no (or not enough) active substance is available in the bath at the beginning of the cleaning step, or the ability to dispense via bleach dispensers of household washing machines does not exist without additional cost.

### BRIEF SUMMARY OF THE INVENTION

The object of the present invention was, therefore, to make available washing- or cleaning-agent shaped elements that are notable for a much improved solubility as compared with known shaped elements of the existing art, with the same or comparable fracture toughness. The shaped elements were intended, in particular, to exhibit improved cold-water solubility. The resulting coated shaped elements were preferably intended to be storable and transportable without further packaging means, in particular without further external packaging made of water-insoluble polymer films.

This object was achieved by a coating method for washing- or cleaning-agent shaped elements in which the shaped-element surface is coated with a surface coverage of between 0.2 and 50 m/cm².

### BRIEF DESCRIPTION OF THE SEVERAL VIEWS OF THE DRAWING(S)

Not Applicable

A method for manufacturing a washing- or cleaning-agent shaped element, encompassing the steps of

a) making available a shaped element that comprises a cavity in the form of a recess or a passthrough hole;

b) applying a coating agent onto the surface of the shaped element so that the surface coverage of the coated shaped-element surface with the coating agent is between 0.2 and 50 mg/cm².

### DETAILED DESCRIPTION OF THE INVENTION

Methods preferred according to the present invention are notable for the fact that the surface coverage of the shaped element is between 0.4 and 40 mg/cm², preferably between 0.8 and 30 mg/cm², and in particular, between 1 and 20 mg/m². The weight proportion of the coating in terms of the total weight of the coated shaped element is preferably less than 2 wt %, by preference less than 1 wt %, particularly preferably less than 0.7 wt %, and in particular, less than 0.4 wt %.

In the method according to the present invention, the coating agents can be used as pure substances, for example, in the form of melts thereof, but also as dispersions or solutions. In addition to water, organic solvents are also suitable as dispersing agents, aqueous dispersions or aqueous solutions being particularly preferred. These dispersions or solutions, in particular, the aqueous dispersions of solutions, by preference account for a weight proportion of the coating agent below 80 wt %, preferably below 65 wt %, particularly preferably below 50 wt %, and in particular, below 40 wt %, based in each case on the total weight of the dispersion or solution,

Impingement of the coating agent onto the shaped element is preferably accomplished by spraying. All apparatuses known to one skilled in the ad for that purpose are suitable for spraying the shaped elements. Spraying is preferably accomplished by means of single fluid or high-pressure spray nozzles, two-fluid spray nozzles, or three-fluid spray nozzles. A high fluid pressure (5-15 MPa) is necessary for spraying with single fluid spray nozzles, while spraying with two-fluid spray nozzles is accomplished with the aid of a stream of compressed air (at 0.15-0.3 MPa), Spraying with two-fluid spray nozzles is more favorable in particular, in terms of possible clogging of the nozzle, but more costly because of the high compressed-air consumption. Additionally usable are three-fluid spray nozzles that, in addition to the stream of compressed air, a further air delivery system that is intended to prevent clogging and droplet formation at the nozzle. In the context of the method according to the present invention, the use of two-fluid spray nozzles, preferably two-fluid spray nozzles having a liquid orifice between 1 and 6 mm, in particular, between 3 and 5 mm, is preferred.

The nozzles in the processing space can spray from top to bottom or from bottom to top. Methods in which the spray apparatus is integrated into the side walls that delimit the process chamber, and is immobilized there, are particularly preferred. Those methods in which two or more spray apparatuses are used in the process chamber are particularly preferred, at least two of the spray apparatuses differing with regard to their orientation, i.e., their spray direction.

In a preferred embodiment of the method according to the present invention, the shaped elements and the spray apparatus are moved relative to one another during the spraying operation. This movement can be implemented both by way of a movement of the shaped element and by way of a movement of the spray apparatus, or by movement of the shaped element and spray apparatus. Those methods in which the spray apparatus is moved in at least one spatial direction, preferably in two or three spatial directions, are particularly preferred. If the shaped elements are simultaneously also moved, the movement direction of the spray apparatus can, for example, extend oppositely to the movement direction of the shaped elements or can coincide therewith. A movement of the spray apparatus orthogonally to the movement direction of the shaped elements can also be performed. The shaped elements can be moved continuously and discontinuously into and through the processing space of the spray apparatus.

The droplet diameter of the sprayed-on coating material or the sprayed-on coating dispersion or solution is preferably between 1 and 100 μm, particularly preferably between 2 and 80 μm, very particularly preferably between 4 and 70 μm and in particular, between 8 and 60 μm. The temperature of the sprayed-on coating material is by preference between 20 and 90° C., preferably between 25 and 60° C., particularly preferably between 30 and 55° C., and in particular, between 40 and 50° C.

The advantages of the method according to the present invention can be realized in particular, by way of those preferred variant methods in which, during spraying of the shaped elements, a surface loading of the shaped-element surface with the sprayed-on liquid is between 0.1 and 200 mg/(cm²s), preferably between 0.2 and 100 mg/(cm²s), particularly preferably between 0.4 and 50 mg/(m²s), and in particular, between 0.8 and 20 mg/(cm²s). Application of the coating agent onto the shaped element is completed by preference in less than 10 minutes, preferably in less than 5 minutes, particularly preferably in less than 2 minutes, very particular preferably in less than 1 minute, and in particular, in less than 0.5 minute.

During the spraying operation, the washing- or cleaning-agent shaped elements are preferably present in isolated fashion, i.e., without direct contact with one another. The method according to the present invention thus differs from those coating methods in which ordered or unordered stacks or piles of shaped elements are coated, for example, in drum coaters or tumbling mixers.

Methods characterized in that the coating agent is sprayed onto the shaped element are particularly preferred.

The sprayed washing- or cleaning-agent shaped element is preferably dried after spraying. Drying can be accomplished, for example, thermally and/or by the action of a vacuum. In the context of thermal drying, methods using hot air or thermal radiation are preferred, Drying temperatures are preferably between 35 and 90° C., preferably between 40 and 80° C. and in particular, between 50 and 70° C. Drying of the shaped elements is usually not accomplished completely, i.e., not all of the quantity of solvent applied as a result of spraying is removed by drying.

Methods in which less than 50% of the applied quantity of solvent is evaporated in the drying step are particularly preferred. This evaporated portion can be ascertained by weighing the uncoated shaped element, the wet shaped element before drying, and the dried shaped element, i.e., from the increase in weight of the shaped element measured before and after drying.

Methods according to the present invention in which a drying step subsequent to the spraying of the shaped elements is omitted are particularly preferred.

Water-soluble organic polymers are preferably used as coating agents. In a preferred variant method, the coating material encompasses one or more water-soluble polymer(s), preferably a material from the group of (optionally acetalized) poly(vinyl alcohol) (PVAL), polyvinylpyrrolidone, polyethylene oxide, gelatin, cellulose, and derivatives and mixtures thereof.

“Poly(vinyl alcohols)” (abbreviated PVAL, occasionally also PVOH) is the designation for polymers having the general structure

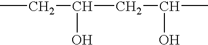

which also contain small proportions (approximately 2%) of structural units of the following type:

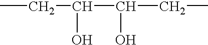

Commercially available poly(vinyl alcohols), which are offered as yellowish-white powders or granules having degrees of polymerization in the range from approximately 100 to 2,500 (molar weights from approximately 4,000 to 100,000 g/mol), have degrees of hydrolysis of 9899 or 87-89 mol %, i.e., still have a residual acetyl group content. Poly(vinyl alcohols) are characterized by manufacturers by indicating the degree of polymerization of the initial polymer, degree of hydrolysis, saponification value, and solution viscosity.

Depending on the degree of hydrolysis, poly(vinyl alcohols) are soluble in water and in less highly polar organic solvents (formamide, dimethylformamide, dimethyl sulfoxide); they are not attacked by (chlorinated) hydrocarbons, esters, fats, and oils. Poly(vinyl alcohols) are categorized as toxicologically unobjectionable, and are least partly biodegradable. Solubility in water can be decreased by subsequent treatment with aldehydes (acetalization), by complexing with Ni or Cu salts, or by treatment with dichromates, boric acid, or borax Coatings made of poly(vinyl alcohols) are largely impermeable to gases such as oxygen, nitrogen, helium, hydrogen, and carbon dioxide, but allow water vapor to pass through.

In the context of the present invention it is preferred that the film material used in the method according to the present invention encompass, at least in portions, a poly(vinyl alcohol) whose degree of hydrolysis is 70 to 100 mol %, preferably 80 to 90 mol % particularly preferably 81 to 89 mol %, and in particular, 82 to 88 mol % In a preferred embodiment, the first film material used in the method according to the present invention encompasses at least 20 we/, particularly preferably at least 40 wt %, very particularly preferably at least 60 wt %, and in particular, at least 80 wt % of a poly(vinyl alcohol) whose degree of hydrolysis is 70 to 100 mol %, preferably 80 to 90 mol %, particularly preferably 81 to 89 mol %, and in particular, 82 to 88 mmol %.

Poly(vinyl alcohols) of a specific molecular-weight range are preferably used as a coating material, it being preferred according to the present invention that the film material encompass a poly(vinyl alcohol) whose molecular weight is in the range from 10,000 to 100,000 gmol⁻¹, preferably from 11,000 to 90,000 gmol⁻¹, particularly preferably from 12,000 to 80,000 gmol⁻¹, and in particular, from 13,000 to 70,000 gmol⁻¹.

The degree of polymerization of such preferred poly(vinyl alcohols) is between approximately 200 and approximately 2,100 preferably between approximately 220 and approximately 1,890, particularly preferably between approximately 240 and approximately 1,680, and in particular, between approximately 260 and approximately 1,500.

The poly(vinyl alcohols) described above are widely available commercially, for example, under the trademark Mowiol® (Clariant). Poly(vinyl alcohols) that are particularly suitable in the context of the present invention are, for example, Mowiol® 3-83, Mowiol® 4-88, Mowiol® 5-88, and Mowiol® 8-88.

Further poly(vinyl alcohols) that are particularly suitable as coating material may be inferred from the table below:

| | Degree of | Molar weight | Melting point |
|---|---|---|---|
| Designation | hydrolysis [%] | [kDa] | [° C.] |
| Airvol ® 205 | 88 | 15-27 | 230 |
| Vinex ® 2019 | 88 | 15-27 | 170 |
| Vinex ® 2144 | 88 | 44-65 | 205 |
| Vinex ® 1025 | 99 | 15-27 | 170 |
| Vinex ® 2025 | 88 | 25-45 | 192 |
| Gohsefimer ® 5407 | 30-28 | 23,600 | 100 |
| Gohsefimer ® LL02 | 41-51 | 17,700 | 100 |

Further poly(vinyl alcohols) that are suitable as coating material are ELVANOL® 51-05, 52-22, 50-42, 85-82, 75-15, T-25, T-66, 90-50 (trademarks of Du Pont), Erkol 05-140, ALCOTEX® 72.5, 78, B72, F80/40, F88/4, F88/26, F88/40, F88/47 (trademarks of Harlow Chemical Co.), Gohsenol® NK-05, A-300, AH-22, C-500, GH-20, GL-03, GM-14L, KA-20, KA-500, KH-20, KP-06, N-300, NH-26, NM11Q, KZ-06 (trademarks of Nippon Gohsei K. K.).

The water solubility of PVAL can be modified by subsequent treatment with aldehydes (acetalization) or ketones (ketalization). Poly(vinyl alcohols) that are acetalized or ketalized with the aldehyde or keto groups of saccharides or polysaccharides or mixtures thereof have proven to be particularly preferred and particularly advantageous because of their extremely good cold-water solubility. The reaction products of PVAL and starch are to be used in extremely advantageous fashion.

Water solubility can furthermore be modified by complexing with Ni or Cu salts or by treatment with dichromates, boric acid, borax, and thereby adjusted specifically to desired values. Films made of PVAL are largely impermeable to gases such as oxygen, nitrogen, helium, hydrogen, carbon dioxide, but allow water vapor to pass through.

Examples of suitable water-soluble PVAL coating materials are the PVAL substances obtainable under the designation “SOLUBLON®” from Syntana Handelsgesellschaft E. Harke GmbH & Co. Their solubility in water can be adjusted to single-degree accuracy, and coating materials of this product series are available that are soluble in the aqueous phase in all temperature ranges relevant for the invention.

Polyvinylpyrrolidones, abbreviated PVPs, can be described by the following general formula:

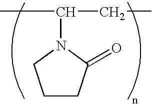

PVPs are manufactured by radical polymerization of 1-vinylpyrrolidone. Commercially usual PVPs have molar weights in the range from approximately 2,500 to 750,000 g/mol and are offered as white, hydroscopic powders or as aqueous solutions.

Polyethylene oxides (abbreviated PEOX) are polyalkylene glycols of the general formula

H—[O—CH₂—CH₂]ₙ—OH

that are manufactured industrially by the alkaline-catalyzed polyaddition of ethylene oxide (oxirane) in systems usually containing small quantities of water, with ethylene glycol as the starting molecule. They have molar weights in the range from approximately 200 to 5,000,000 g/mol, corresponding to degrees of polymerization n from approximately 5 to >100,000. Polyethylene oxides possess an extremely low concentration of reactive hydroxy end groups, and exhibit only weak glycol properties,

Gelatin is a polypeptide (molar weight: approximately 15,000 to >250,000 g/mol) that is obtained principally by hydrolysis, under acid or alkaline conditions, of the collagen contained in animal skin and bones. The amino acid composition of gelatin corresponds largely to that of the collagen from which it was obtained, and varies depending on its provenance.

Coating materials that encompass a polymer from the group of starch and starch derivatives, cellulose and cellulose derivatives, in particular, methyl cellulose, and mixtures thereof, are preferred in the context of the method according to the present invention.

Starch is a homoglycan, the glucose units being linked in α-glycosidic fashion. Starch is made up of two components having different molecular weights: approximately 20 to 30% straight-chain amylose (m.w. approximately 50,000 to 150,000) and 70 to 80% branched-chain amylopectin (m.w. approximately 300,000 to 2,000,000). Small quantities of lipids, phosphoric acid, and cations are also additionally present. While the amylose, because of the bond in the 1,4-position, forms helical, intertwined chains having approximately 300 to 1,200 glucose molecules, in amylopectin the chain branches after an average of 25 glucose units (because of the 1,6-bond) to yield a ramified structure having approximately 1,500 to 12,000 molecules of glucose. In addition to pure starch, starch derivatives that are obtainable from starch by polymer-analogous reactions are also suitable for the manufacture of coatings in the context of the present invention. Chemically modified starches of this kind encompass, for example, products of esterification or etherification processes in which hydroxy hydrogen atoms are substituted. Starches in which the hydroxy groups have been replaced by functional groups that are not bound via an oxygen atom can, however, also be used as starch derivatives. Included in the group of the starch derivatives are, for example, alkali starches, carboxymethyl starch (CMS), starch esters and ethers, and amino starches.

Pure cellulose has the formal gross composition (C₈H₁₀O₅)ₙ and constitutes, in formal terms, a β-1,4-polyacetal of cellobiose, which in turn is constructed from two molecules of glucose. Suitable celluloses are made up of approximately 500 to 5,000 glucose units and consequently have average molar weights from 50,000 to 500,000. Also usable in the context of the present invention as cellulose-based disintegrating agents are cellulose derivatives that are obtainable from cellulose by polymer-analogous reactions. Chemically modified celluloses of this kind encompass, for example, products of esterification or etherification processes in which hydroxy hydrogen atoms are substituted. Celluloses in which the hydroxy groups have been replaced by functional groups that are not bound via an oxygen atom can also be used, however, as cellulose derivatives. Included in the group of the starch derivatives are, for example, alkali celluloses, carboxymethyl cellulose (CMC), cellulose esters and ethers, and aminocelluloses.

Further preferred coating materials are characterized in that they encompass hydroxypropylmethyl cellulose (HPMC) that has a degree of substitution (average number of methoxy groups per anhydroglucose unit of the cellulose) from 1.0 to 2.0, preferably from 1.4 to 1.9, and a molar substitution (average number of hydroxypropoxy groups per anhydroglucose unit of the cellulose) from 0.1 to 0.3 preferably from 0.15 to 0.25.

Particularly preferred are those methods according to the present invention in which a water-soluble organic polymer, preferably a polymer from the group of poly(vinyl alcohol), polyvinylpyrrolidone, and cellulose ethers, is used. Mixtures of different substances in the form of their melts, solutions, or dispersions can of course also be used as coating materials.

The method according to the present invention is suitable for simple and for repeated coating of the shaped elements. Methods characterized in that the coating agent is applied onto the shaped element by the fact that the shaped element is sprayed multiple times with a solution or a dispersion of the coating agent are preferred according to the present invention. A “multiple” or “repeated” coating of the shaped element is accomplished in such a way that the shaped element is at least superficially dried between the individual coating steps. The coating steps are consequently interrupted by a drying step, but at least by a waiting time that preferably exceeds at least one minute, by preference two minutes, and in particular, at least three minutes. Drying steps that are performed under more drastic conditions, i.e., at elevated temperature and/or greater vacuum, can preferably be decreased to at least 10 seconds, particularly preferably at least 30 seconds, by preference at least 40 seconds, and in particular, to at least 50 seconds.

The surface coverage of the shaped elements after this repeated coating is preferably between 0.2 and 100 mg/cm², preferably between 1 and 80 mg/cm², particularly preferably between 10 and 70 mg/cm², and in particular, between 20 and 60 mg/cm².

A further subject of the present invention is, therefore, a method for manufacturing a washing- or cleaning-agent shaped element encompassing the steps of

a) making available a shaped element that comprises a cavity in the form of a recess or a passthrough hole;

b) repeatedly applying a coating agent onto the surface of the shaped element so that the surface coverage of the coating shaped-element surface with the coating agent is, for each coating operation, between 0.2 and 50 mg/cm².

Particularly preferred are those methods according to the present invention in which the shaped elements are coated twice, three times, or four times. If the coating is repeated multiple times, different coating agents can also be used in the individual coating steps, depending on the field of application of the washing- or cleaning-agent shaped elements. Methods of this kind in which different coating materials are used are particularly preferred according to the present invention.

Further coating materials that are suitable in combination with the particularly preferred water-soluble polymers, for example, in the form of a melted, dissolved, or dispersed mixture, or a second or third coating material in the context of a repeated coating of the shaped elements, are

a) the LCST substances

b) the waxes

c) the paraffins.

The LCST substances are substances that exhibit better solubility at low temperatures than at higher temperatures. They are also referred to as substances having a low critical solution temperature. These substances are, as a rule, polymers. Depending on application conditions, the lower critical solution temperature should be between room temperature and the heat treatment temperature for examples between 20° C., preferably 30° C., and 100° C., in particular, between 30° C. and 50° C. The LOST substances are preferably selected from alkylated and/or hydroxyalkylated polysaccharides, cellulose ethers, polyisopropylacrylamide, copolymers of polyisopropylacrylamide, and blends of these substances.

Examples of alkylated and/or hydroxyalkylated polysaccharides are methylhydroxypropylmethyl cellulose (MHPC), ethyl(hydroxyethyl) cellulose (EHEC), hydroxypropyl cellulose (HPC), methyl cellulose (MC), ethyl cellulose (EC), carboxymethyl cellulose (CMC), carboxymethylmethyl cellulose (CMMC), hydroxybutyl cellulose (HBC), hydroxybutylmethyl cellulose (HBMC), hydroxyethyl cellulose (HEC), hydroxyethylcarboxymethyl cellulose (HECMC), hydroxyethylethyl cellulose (HEEC), hydroxypropyl cellulose (HPC), hydroxypropylcarboxymethyl cellulose (HPCMC), hydroxyethylmethyl cellulose (HEMC), methylhydroxyethyl cellulose (MHEC), methylhydroxyethylpropyl cellulose (MHEPO), methyl cellulose (MC), and propyl cellulose (PC) and mixtures thereof, carboxymethyl cellulose, methyl cellulose, methylhydroxyethyl cellulose and methylhydroxypropyl cellulose, as well as the alkali salts of CMC and the easily ethoxylated MC, or mixtures of the above, being preferred.

Further examples of LCST substances are cellulose ethers as well as mixtures of cellulose ethers with carboxymethyl cellulose (CMC). Further polymers that exhibit a lower critical solution temperature in water and that are likewise suitable are polymers of mono- or di-N-alklylated acrylamides, copolymers of mono or di-N-substituted acrylamides with acrylates and/or acrylic acids, or mixtures of mutually intertwined networks of the aforesaid (co)polymers. Additionally suitable are polyethylene oxide or copolymers thereof, such as ethylene oxide/propylene oxide copolymers and graft copolymers of alkylated acrylamides with polyethylene oxide, polymethacrylic acid, poly(vinyl alcohol), and copolymers thereof, polyinylmethyl ethers, certain proteins such as poly(VATGW), a repeating unit in the natural protein elastin, ad certain alginates. Mixtures of these polymers with salts or surfactants can likewise be used as an LCST substance. The LCST (lower critical solution temperature) can be correspondingly modified by such additions or by way of the degree of cross-linking of the polymers.

“Waxes” are understood as a number of natural or artificially obtained substances that as a rule melt above 35° C. without decomposition, and just above the melting point are already relatively low in viscosity and not stringy. They exhibit a highly temperature-dependent consistency and solubility. Waxes are divided into three groups depending on their derivation: natural waxes, chemically modified waxes, and synthetic waxes.

The natural waxes include, for example, vegetable waxes such as candelilla wax, carnauba wax, Japan wax, esparto grass wax, cork wax, guaruma wax, rice seed oil wax, sugar cane wax, ouricury wax, or montan wax; animal waxes such as beeswax, shellac wax, spermaceti, lanolin (wool wax), or uropygial grease; mineral waxes such as ceresin or ozocerite (earth wax); or petrochemical waxes such as petrolatum, paraffin waxes, or microcrystalline waxes.

The chemically modified waxes include, for example, hard waxes such as montan ester waxes, sassol waxes, or hydrogenated jojoba waxes.

Synthetic waxes are usually understood to be polyalkylene waxes or polyalkylene glycol waxes. Also usable as coating materials are compounds from other substance classes that meet the stated requirements in terms of softening point. For example, higher esters of phthalic acid, in particular, dicyclohexyl phthalate, which is commercially available under the name Unimoll® 66 (Bayer AG), have proven to be suitable synthetic compounds. Also suitable are synthetically produced waxes from lower carboxylic acids and fatty alcohols, for example, dimyristyl tartrate, which is obtainable under the name Cosmacol® ETLP (Condea). Also usable, conversely, are synthetic or partially synthetic esters from lower alcohols with fatty acids from natural sources. This substance class contains, for example, Tegin® 90 (Goldschmidt), a glycerol monostearate-palmitate. Shellac, for example, Schellack-KPS-Dreiring-SP (Kalkhoff GmbH), is also usable as a further substance.

Also considered among the waxes in the context of the present invention are, for example, the so-called waxy alcohols. Waxy alcohols are higher-molecular-weight, water-insoluble fatty alcohols usually having approximately 22 to 40 carbon atoms. The waxy alcohols occur, for example, in the form of wax esters of higher-molecular-weight fatty acids (waxy acids), as a principal constituent of many natural waxes. Examples of waxy alcohols are lignoceryl alcohol (1-tetracosanol), cetyl alcohol, myristyl alcohol, or melissyl alcohol. The coating can, if applicable, also contain wool wax alcohols, which are understood as triterpenoid and steroid alcohols, for example, lanolin, which is obtainable e.g., under the commercial name Argowax® (Pamentier & Co.). Also usable as at least a partial constituent of the coating in the context of the present invention are fatty acid glycerol esters or fatty acid alkanoiamides, but if applicable also water-insoluble or poorly water-soluble polyalkylene glycol compounds.

“Paraffin” is the designation for a solid or liquid mixture of purified, saturated aliphatic hydrocarbons (paraffins). It is readily soluble in ether and chloroform, but not soluble in water. Both liquid paraffins and paraffin melts can be used in the context of the present invention.

Because of their dissolution properties, the liquid and solid paraffins are preferably used as a solution or dispersion in an organic solvent or solvent mixture. Utilization of the paraffins without the addition of solvents, in the form of the melts or liquids, is, however, also possible.

Paraffin waxes have the advantage in the context of the present invention, as compared with the other natural waxes mentioned, that when preferred washing- or cleaning-agent shaped elements coated with paraffin waxes are used in an alkaline cleaning-agent environment, no hydrolysis of the waxes (as may be expected, for example, in the case of the waxy esters) takes place, since paraffin wax contains no hydrolyzable groups.

Paraffin waxes are made up principally of alkanes, as well as small proportions of iso- and cycloalkanes. The paraffin to be used according to the present invention preferably has substantially no constituents having a melting point of more than 70° C., particularly preferably more than 60° C.

Preferred coating materials contain at least one paraffin wax having a melting range from 40° C. to 60° C.

The concentration, in the paraffin wax used, of alkanes, isoalkanes, and cycloalkanes that are solid at ambient temperature (usually approximately 10 to approximately 30° C.) is preferably as high as possible. The more solid wax constituents are present in a wax at room temperature, the more usable it is in the context of the present invention.

Paraffin waxes applied in the form of their melts solidify preferably within 10 minutes, by preference within 5 minutes, and in particular, within 2 minutes.

The use of hydrophobic substances as a coating material is preferred in the present invention, since these substances improve the storage behavior of the washing- or cleaning-agent shaped elements according to the present invention at high relative humidities. The elevated moisture resistance of the coated elements makes it possible, after application of a hydrophobic substance, to omit any sealing with a water-soluble or water-dispersible film. This is, however, only a preferred embodiment of the method according to the present invention. On the other hand, it can be preferred to apply the film onto the hydrophobically coated shaped element. The film can at least in part be fuse together with the film, rest in place loosely (i.e., enclose the element), or also contain an air cushion so that the shaped element is additionally protected from mechanical effects.

In a preferred embodiment of the method according to the present invention, the shaped elements are coated twice, three times, or four times, in which context the same or different coating materials can be used in the respective coating operations. A fundamental distinction is made in the context of the present application between coating materials from the group of the water-soluble polymers (e.g., PVA, PVP, gelatin, or LCST polymers) and the water-insoluble waxes and paraffins. The table below provides an overview of a number of particularly preferred sequences of these coating materials. The coating characterized as “Layer 1” corresponds to the layer applied first onto the shaped element.

Within the following table, the slash (/) has the meaning of an “and/or” relationship.

| Layer 1 | Layer 2 | Layer 3 | Layer 4 |
|---|---|---|---|
| PVA | | | |
| PVA/LCST | Wax/paraffin | | |
| Wax/paraffin | | | |
| PVA | PVA | — | — |
| PVA | PVA | PVA | — |
| PVA | PVA | PVA | PVA |
| PVA | LCST | — | — |
| PVA | LCST | Wax/paraffin | — |
| PVA | PVA | LCST | — |
| PVA | PVA | LCST | Wax/paraffin |
| PVA | LCST | PVA | PVA |
| PVA | PVA | LCST | PVA |
| PVA | PVA | PVA | LCST |
| PVA | Wax/paraffin | LCST | PVA |
| PVA | PVA | Wax/Paraffin | LCST |
| Wax/paraffin | PVA | PVA | PVA |
| Wax/paraffin | PVA | LCST | PVA |

Active substances and ingredients can b mixed into the coating materials. Dyes, fragrances, or bitter substances are preferably added to the coating materials.

The three-dimensional shape of the washing- or cleaning-agent shaped elements is subject to no limitations. Examples are three dimensional solids having a polygonal base outline, the solid representing an extension of the polygonal base outline in space. Preferred examples of solids having a polygonal base outline are prismatic solids. Examples of prismatic solids are trigonal prisms, rhombic prisms, orthorhombic prisms, tetragonal prisms, pentagonal prisms, hexagonal prisms, or octagonal prisms. A cuboidal shape is particularly preferred. Examples of further suitable polygonal solids are trigonal, tetragonal, rhombic, orthorhombic, hexagonal, or octagonal pyramids and dipyramids. According to the present invention, the solid can also be a mixed form of different geometrical solids. Additionally preferred are shaped elements having an oval or round base outline, the solid preferably once again representing an extension of the base outline in space.

The volume of the washing- or cleaning-agent shaped elements is preferably between 12 and 30 ml, by preference between 15 and 25 ml, and in particular, between 17 and 22 ml. The weight of the shaped elements is preferably between 10 and 25 g. Washing- or cleaning-agent shaped elements of this kind are suitable in particular, as dispensing units for one-time use. These shaped elements are usually dispensed via the bleach dispensers of washing machines or automatic dishwashers. The three-dimensional shape of the shaped element can therefore, of course, also be adapted to any irregular shapes of the dispensing compartments/bleach dispensers of different washing machines and automatic dishwashers. A cuboidal shape of the washing- or cleaning-agent shaped element is preferred to the extent that as a result, usual cuboidal bleach dispensers or automatic dishwashers can be optimally filled in terms of volume. In addition, washing or cleaning agents of cuboidal proportions can be stored in highly space-saving fashion.

Also usable, in particular, are shaped elements having convex or concave lateral surfaces. One preferred embodiment of a shaped element having a concave lateral surface is the recess shaped element. The recess volume of these shaped elements preferably corresponds to at least 10 vol %, preferably at least 20 vol %, and in particular, at least 40 vol % of the shaped-element volume (without the recess).

As an alternative to a recess, the washing- or cleaning-agent shaped elements can comprise a cavity in the form of a passthrough hole. The openings of this hole can be located in adjacent lateral surfaces and/or in opposite lateral surfaces of the shaped element. If the openings of the hole are located on mutually opposite sides of the shaped element the corresponding shaped elements are then also referred to as annular shaped elements or ring tablets.

The shaped elements used in the method according to the present invention can be, for example, molded elements, (continuous) extrudates, or compactates. Tablets are used with particular preference as shaped elements. For the manufacture of tablets, particulate premixes are compacted in a so-called mold between two dies, yielding a solid compressed body. This operation, which will be referred to hereinafter for brevity's sake as tableting, is subdivided into four portions: metering, compaction (elastic deformation), plastic deformation, and ejection.

First the premix is introduced into the mold, the fill quantity and, therefore, the weight and the shape of the resulting shaped element being determined by the position of the lower die and the shape of the pressing tool Consistent metering even at high shaped-element throughput rates is preferably achieved by volumetric metering of the premix. This requires good pourability of the premix and a not excessively coarse particle structure, which is achieved preferably by sieving using a sieve that has a mesh size of 1.6 mm, preferably 1.5 mm, and in particular, 1.4 mm. As tableting proceeds, the upper die comes into contact with the premix and moves farther downward toward the lower die. This compaction causes the particles of the premix to be pressed closer to one another, while the cavity volume inside the filled material between the dies continuously decreases. Beyond a certain position of the upper die (and, therefore, above a certain pressure on the premix), plastic deformation begins in which the particles merge together and formation of the shaped element occurs. Depending on the physical properties of the premix, some of the premix particles are also crushed, and at even higher pressures a sintering of the premix occurs. As the pressing speed rises, i.e., at high throughput rates, the elastic deformation phase becomes increasingly shorter, so that the resulting shaped elements may exhibit voids of varying sizes. In the last phase of tableting, the completed shaped elements are pushed out of the mold by the lower die, and are carried away by downstream transport devices. At this point in time only the weight of the shaped element is completely defined, since physical processes (rebound, crystallographic effects, cooling, etc.) can still cause the shape and size of the compacts to change.

Tableting is performed in commercially available tableting presses that can be equipped in principle with single or double dies. In the latter case only the upper die is used to build up pressure; the lower die also moves toward the upper die during the pressing process, while the upper die pushes downward. For small production volumes it is preferred to use eccentric tableting presses in which the die or dies are attached to an eccentric disk that in turn is mounted on a shaft having a specific rotation speed. The movement of these pressing dies is comparable to the manner of operation of a conventional four-stroke engine. Compression can be accomplished using one upper and one lower die, but multiple dies can also be attached to one eccentric disk, the number of mold orifices being correspondingly increased. The throughput rates of eccentric presses vary, depending on type, from a few hundred to a maximum of 3,000 tablets per hour.

In eccentric presses, the lower die is generally not moved during the pressing operation. One consequence of this is that the resulting tablet exhibits a hardness gradient, i.e., is harder in the regions that were closer to the upper die than in the regions that were closer to the lower die.

Rotary tablet presses, in which a larger number of molds is arranged in a circle on a so-called mold table, are selected for higher throughput rates. The number of molds varies, depending on the model, from six to 55, even larger molds being commercially available. Each mold on the mold table has an upper and a lower die associated with it; once again the applied pressure can be actively built up only by the upper or lower die, but also by both dies. The mold table and the dies move about a common vertically oriented axis, the dies being brought during rotation, with the aid of rail-like curved tracks, into the positions for filling, compaction, plastic deformations and ejection. At the points where a particularly pronounced raising or lowering of the dies is necessary (filling, compaction, ejection), these curved tracks are assisted by additional press-down elements, pull-down rails, and lifting tracks. The molds are filled via a rigidly arranged delivery device called the filling shoe, which is connected to a reservoir for the premix. The applied pressure on the premix is individually adjustable by way of the pressing travels for the upper and lower dies, pressure being built up as the die shaft heads roll past displaceable pressure rollers,

To increase the throughput rate, rotary presses can also be equipped with two filling shoes, in which case only a half-circle rotation is necessary in order to produce a tablet. For the production of two-layer and multi-layer shaped elements, multiple filling shoes are arranged one behind the other, and the slightly compressed first layer is not ejected before further filling. With appropriate process control, it is possible in this fashion also to produce coated tablets and core tablets that have an onion-like structure; in the case of core tablets, the top of the core or of the core layers is not covered and thus remains visible. Rotary tableting presses can also be fitted with single or multiple molds so that, for example, an outer circle having 50 orifices and an inner circle having 35 orifices can be used simultaneously for compression. The throughput rates of modern rotary tableting presses are over a million shaped elements per hour.

The tablets can of course likewise, in the context of the present invention, be configured in multiphase, in particular, multi-layer, fashion. The shaped elements can be produced in a predetermined three-dimensional shape and a predetermined size, Practically all configurations that can reasonably be handled are suitable as a three-dimensional shape, is., for example, the embodiment as a slab, the rod or bar shape, cubes, cuboids, and corresponding three-dimensional elements having flat lateral surfaces, as well as, in particular, cylindrical configurations having a circular or oval cross section. This latter configuration encompasses the presentation form from the tablet to compact cylindrical pieces having a ratio of height to diameter greater than 1.

After pressing, the washing- or cleaning-agent shaped elements exhibit excellent stability. The fracture resistance of cylindrical shaped elements can be determined by way of the measured variable of the diametrical fracture stress. This can be ascertained as

$$σ = \frac{2 P}{π Dt}$$

where σ denotes the diametral fracture stress (DFS) in Pa, P is the force in N that results in the pressure exerted on the shaped element that causes fracture of the shaped element. D is the shaped-element diameter in meters, and t is the height of the shaped element.

As stated initially, the stability and fracture toughness of the processed shaped elements can be improved without impairing their disintegration and dissolution properties. In other words, the shaped elements are notable, after coating, for an elevated fracture resistance with no change in dissolution behavior. This unexpected effect becomes particularly evident when using the above-described shaped elements that comprise a cavity in the form of a recess or a passthrough hole, and in particular, when the coating in step b) is applied onto the external surfaces of the shaped element but not inside the cavity. For industrial-scale processes, a slight “contamination” of the surfaces inside the cavity cannot be avoided in certain circumstances. This “contamination” should, however, preferably be less than 10 wt %, preferably less than 5 wt %, and in particular, less than 3 wt % of the total quantity of coating agent applied.

Preferred methods according to the present invention are, therefore characterized in that the coating in step b) is performed onto the external surfaces of the shaped element having the cavity, but not inside the cavity.

A preferred subject of the present invention is, therefore, a method for manufacturing a washing- or cleaning-agent shaped element encompassing the steps of

a) making available a shaped element, preferably a tablet, that comprises a cavity in the form of a recess or a passthrough hole;

b) applying a coating agent onto the surface of the shaped element so that the surface coverage of the coated shaped-element surface with the coating agent is between 0.2 and 50 mg/cm², the coating being applied onto the external surfaces of the shaped element but not inside the cavity.

With particular advantage, in this variant method as well the coating of the shaped element is performed repeatedly, preferably twice, three times, or four times.

The cavity of the above-described recessed or annular shaped elements are filled, in a preferred variant method, with a substance having washing or cleaning activity or a substance mixture having washing or cleaning activity. Preferred as filling materials are a) particulate compositions from the group of the powders, granules, or extrudates, or b) liquid or gelled preparations. Solutions or melts, for example, can be introduced as liquid preparations, Filling of the cavity can be accomplished before or after application of the coating material, but also between two coating steps. Methods in which filling is accomplished after the coating of the shape element are preferred.

The substances or substance mixtures introduced into the cavity can be retained in the cavity in different ways. In a first preferred embodiment, the substances or substance mixtures are retained in the cavity by adhesion. In a further preferred embodiment, the substances or substance mixtures are located in a water-soluble or water-dispersible package, for example, a deep-drawn pouch or an injection-molded container, which at least partially fills up the cavity and in turn is joined to the shaped element by adhesion or by a mechanical connection, for example, a latching, snap-lock, plug-in, or damped connection.

The cavity is filled by preference to a proportion of at least 70 vol %, preferably at least 80 vol %, particularly preferably at least 90 vol %, and in particular, at least 95 vol % of its volume.

In a particularly preferred embodiment of the method according to the present invention, a water-soluble or water-dispersible film is sealed onto the coated surface of the shaped element after coating, the sealing preferably being accomplished by heat-sealing.

The sealed-on film can perform a number of different functions. For example, a film of this kind is suitable for retaining in the cavity of the shaped element substances or substance mixtures introduced into said cavity. In addition, the fracture strength and/or storage stability of the shaped element can be further increased by means of these films. The water-soluble polymers recited above from the group of (optionally acetalized) poly(vinyl alcohol) (PVAL), polyvinylpyrrolidone, polyethylene oxide, gelatin, cellulose, and derivatives and mixtures thereof, are used in particular, as preferred film materials.

It has been found, surprisingly, that the sealing of the aforesaid films onto the shaped elements coated according to the present invention are notable for elevated strength and sealing tightness as compared with sealing operations on conventional shaped elements.

A further subject of the present application is a coated washing- or cleaning-agent shaped element characterized in that the surface coverage of the coating shaped-element surface with the coating agent is between 0.2 and 50 mg/cm².

With regard to the preferred embodiments for these shaped elements, the statements made for the method according to the present invention apply mutatis mutandis.

In particular, preferred coated washing- or cleaning-agent shaped elements exhibit after a surface coverage of the coating shaped-element surface with the coating agent of between 0.4 and 40 mg/cm², preferably between 0.8 and 30 mg/cm², and in particular, between 1 and 20 mg/cm².

The coating agent is preferably a water-soluble organic polymer, preferably a polymer from the group of poly(vinyl alcohol), polyvinylpyrrolidone, and cellulose ethers.

The fracture toughness of the coated washing- or cleaning-agent shaped elements is by preference above 60 N, preferably above 80 N, particularly preferably above 100 N, and in particular, above 110 N.

The shaped elements preferably comprise a cavity in the form of a recess or a passthrough hole, those shaped elements that is coated on the external surfaces but not inside the cavity being particularly preferred.

The cavity of the shaped elements according to the present invention is preferably filled.

Preferred coated washing- or cleaning-agent shaped elements are characterized in that the shaped element encompasses a coated surface as well as a water-soluble or water-dispersible film, the coating and the water-soluble or water-dispersible film being at least in part fused to one another

The agents according to the present invention described above and the agents manufactured according to the method described above contain substances having washing and cleaning activity, preferably substance having washing and cleaning activity from the group of the detergency builders, surfactants, polymers, bleaching agents, bleach activators, enzymes, glass corrosion inhibitors, corrosion inhibitors, disintegration adjuvants, fragrances, and perfume carriers. The agents are therefore, as a rule water-soluble or water-dispersible. The preferred ingredients of these agents are described in more detail below.

### Detergency Builders.

The builders include, in particular, the zeolites, silicates, carbonates, organic co-builders, and also (if there are no environmental prejudices against their use) the phosphates.

The finely crystalline synthetic zeolite containing bound water that is used is preferably zeolite A and/or zeolite P. Zeolite MAP® (commercial product of the Crosfield Co.) is particularly preferred as zeolite P. Also suitable, however, are zeolite X as well as mixtures of A, X, and/or P. Also commercially available and preferred for use in the context of the present invention is, for example, a co-crystal of zeolite X and zeolite A (approximately 80 wt % zeolite X) that is marketed by CONDEA Augusta S.p.A, under the trade name VEGOBOND AX® and can be described by the formula

nNa₂O(1−n)K₂OAl₂O₃(2−2.5)SiO₂(3.5−5.5)H₂O

The zeolite can be used both as a builder in a granular compound and as a kind of “dusting” of a granular mixture, preferably a mixture that is to be compressed, both approaches to incorporating the zeolite into the premixture usually being used. Suitable zeolites exhibit an average particle size of less than 10 μm (volume distribution; measurement method, Coulter Counter), and preferably contain 18 to 22 wt %, in particular, 20 to 22 wt %, bound water.

Suitable crystalline, sheet-form sodium silicates possess the general formula NaMSiₓO₂ₓ₊₁—H₂O, where M denotes sodium or hydrogen, x is a number from 1.9 to 4, and y is a number from 0 to 20, and preferred values for x are 2, 3, or 4. Preferred crystalline sheet silicates of the formula indicated above are those in which M denotes sodium and x assumes the value 2 or 3. Both β- and δ-sodium disilicates Na₂Si₂O₅.yH₂O are particularly preferred.

Crystalline sheet-form sodium silicate of the general formula NaMSiₓO₂ₓ₊₁.yH₂O, where M denotes sodium or hydrogen, x a number from 1.9 to 22, preferably from 1.9 to 4, and y denotes a number from 0 to 33, are used with particular preference especially as a constituent of automatic dishwashing agents. The crystalline sheet-form silicates of the formula NaMSiₓO₂ₓ₊₁.yH₂O are marketed, for example, by Clariant GmbH (Germany) under the trade name Na-SKS. Examples of these silicates are Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O), or Na-SKS-4 (Na₂Si₄O₉.xH₂O, makatite).

Particularly suitable for purposes of the present invention are crystalline sheet-form silicates of the formula NaMSiₓO₂ₓ₊₁.yH₂O in which x denotes 2. Especially suitable, of these, are Na-SKS-5 (α-Na₂Si₂O₅), Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-11 (t-Na₂Si₂O₅), and Na-SKS-13 (NaHSi₂O₅), but in particular, Na-SKS-6 (δ-Na₂Si₂O₅).

If the silicates are used as a constituent of automatic dishwashing agents, these agents preferably contain a weight proportion of the crystalline sheet-form silicate of the formula NaMSiₓO₂ₓ₊₁.yH₂O from 0.1 to 20 wt %, from 0.2 to 15 wt %, and in particular, from 0.4 to 10 wt %, based in each case on the total weight of said agents. It is, in particular, particularly preferred when such automatic dishwashing agents have a total silicate content below 7 wt %, by preference below 6 wt %. preferably below 5 wt %, particularly preferably below 4 wt %, very particularly preferably below 3 wt %, and in particular, below 2.5 wt %, this silicate being preferably at least 70 wt %, by preference at least 80 wt %, and in particular, 90 wt % (based on the total weight of the contained silicate) silicate of the general formula NaMSiₓO₂ₓ₊₁.yH₂O.

Also usable are amorphous sodium silicates having a Na₂O:SiO₂ modulus of 1:2 to 1:3.3, preferably 1.2 to 1:2.8, and in particular, 1:2 to 1:2.6, which are dissolution-delayed and exhibit secondary washing properties. A dissolution delay as compared with conventional amorphous sodium silicates can have been brought about in various ways, for example, by surface treatment, compounding, compacting/densification, or overdrying. In the context of this invention, the term “amorphous” is also understood to mean “X-amorphous.” In other words, in X-ray diffraction experiments the silicates yield not the sharp X-ray reflections that are typical of crystalline substances, but at most one or more maxima in the scattered X radiation, having a width of several degree units of the diffraction angle. Particularly good builder properties can, however, very easily be obtained even if the silicate particles yield blurred or even sharp diffraction maxima in electron beam diffraction experiments. This may be interpreted to mean that the products have microcrystalline regions 10 to several hundred nm in size, values of up to a maximum of 50 nm, and in particular, a maximum of 20 nm, being preferred. So-called X-amorphous silicates of this kind likewise exhibit a dissolution delay as compared with conventional water glasses. Densified/compacted amorphous silicates, con-pounded amorphous silicates, and overdried X-amorphous silicates are particularly preferred.

In the context of the present invention, it is preferred that this/these silicate(s), preferably alkali silicates, particularly preferably crystalline or amorphous alkali disilicates, be contained in washing or cleaning agents in quantities from 10 to 60 wt %, preferably 15 to 50 wt %, and in particular, 20 to 40 wt %, based in each case on the weight of the washing or cleaning agent.

Use of the generally known phosphates as builder substances is also, of course, possible, provided such use is not to be avoided for environmental reasons. This applies in particular, to the use of agents according to the present invention, or manufactured by means of methods according to the present invention, as automatic dishwashing agents, which is particularly preferred in the context of the present application. Among the plurality of commercially available phosphates, the alkali-metal phosphates, with particular preference for pentasodium or pentapotassium triphosphate (sodium or potassium tripolyphosphate), have the greatest significance in the detergent and cleaning agent industry.

“Alkali-metal phosphates” is the summary designation for the alkali-metal (in particular, sodium and potassium) salts of the various phosphoric acids, in which context a distinction can be made between metaphosphoric adds (HPO₃)ₙ and orthophosphoric acid H₃PO₄, in addition to higher-molecular-weight representatives. The phosphates offer a combination of advantages: they act as alkali carriers, prevent lime deposits on machine parts and lime encrustations in fabrics, and furthermore contribute to cleaning performance.

Suitable phosphates are, for example, sodium dihydrogenphosphate, NaH₂PO₄, in the form of the dihydrate (density 1.91 gcm⁻³, melting point 60° C.) or in the form of the monohydrate (density 2.05 gcm⁻³), disodium hydrogenphosphate (secondary sodium phosphate), Na₂HPO₄, which can be used anyhdrously or with 2 mol (density 2.066 gcm⁻³, water lost at 95°), 7 mol (density 1.68 gcm⁻³, melting point 48° with loss of 5H₂O), and 12 mol of water (density 1.52 gcm⁻³, melting point 35° with loss of 5H₂O), but in particular, trisodium phosphate (tertiary sodium phosphate), Na₃PO₄, which can be used as the dodecahydrate, the decahydrate (corresponding to 19-20% P₂O₅), and in anhydrous form (corresponding to 39-40% P₂O₅).

A further preferred phosphate is tripotassium phosphate (tertiary or tribasic potassium phosphate), K₃PO₄. Also preferred are tetrasodium diphosphate (sodium pyrophosphate), Na₄P₂O₇, which exists in anhydrous form (density 2.534 gcm⁻³, melting point 988°, also indicated as 880°) and as the decahydrate (density 1.815-1.836 gcm⁻³, melting point 94° with loss of water), and the corresponding potassium salt potassium diphosphate (potassium pyrophosphate), K₄P₂O₇.

The technically important pentasodium triphosphate Na₅P₃O₁₀ (sodium tripolyphosphate) is a Bite, water-soluble, non-hygroscopic salt, crystallizing anhydrously or with 6H₂O, of the general formula NaO—[P(O)(ONa)—O]ₙ—Na, where n=3. The corresponding potassium salt pentapotassium triphosphate K₅P₃O₁₀ (potassium tripolyphosphate) is marketed, for example, in the form of a 50-wt % solution (>23% P₂O₅, 25% K₂O). The potassium polyphosphates are widely used in the washing- and cleaning-agent industry. Sodium potassium tripolyphosphates also exist and are likewise usable in the context of the present invention. They are produced, for example, when sodium trimetaphosphate is hydrolyzed with KOH.

(NaPO₃)₃+2KOH→Na₃K₂P₃O₁₀+H₂O

These are usable according to the present invention in just the same way as sodium tripolyphosphate, potassium tripolyphosphate, or mixtures of the two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate are also usable according to the present invention.

If phosphates are used in washing or cleaning agents in the context of the present application as substances having washing or cleaning activity, preferred agents then contain this/these phosphate(s), preferably alkali-metal phosphate(s), particularly preferably pentasodium or pentapotassium triphosphate (sodium or potassium tripolyphosphate), in quantities from 5 to 80 wt %, preferably 15 to 75 wt %, and in particular, 20 to 70 wt %, based in each case on the weight of the washing or cleaning agent.

It is preferred in particular, to use potassium tripolyphosphate and sodium tripolyphosphate at a weight ratio of more than 1:1, by preference more than 2:1, preferably more than 5:1, particularly preferably more than 10:1, and in particular, more than 20:1. It is particularly preferred to use exclusively potassium tripolyphosphate with no admixtures of other phosphates.

Additional builders are the alkali carriers. Alkali carriers are considered to be, for example, alkali-metal hydroxides, alkali-metal carbonates, alkali-metal hydrogencarbonates, alkali-metal sesquicarbonates, the aforesaid alkali silicates, alkali metasilicates, and mixtures of the aforesaid substances, the alkali carbonates, in particular, sodium carbonate, sodium hydrogencarbonate, or sodium sesquicarbonate, being used in preferred fashion for purposes of this invention. A builder system containing a mixture of tripolyphosphate and sodium carbonate is particularly preferred. Likewise particularly preferred is a builder system containing a mixture of tripolyphosphate and sodium carbonate and sodium disilicate.

Because their compatibility with the other ingredients of washing or cleaning agents is low as compared with other builder substances, the alkali-metal hydroxides are preferably used only in small quantities, by preference in quantities below 10 wt %, preferably below 6 wt %, particularly preferably below 4 wt %, and in particular, below 2 wt %, based in each case on the total weight of the washing or cleaning agent. Agents that contain, based on their entire weight, less than 0.5 wt % and in particular, no alkali-metal hydroxides, are particularly preferred.

The use of carbonate(s) and/or hydrogencarbonate(s), preferably alkali carbonate(s), particularly preferably sodium carbonate, in quantities from 2 to 50 wt %, preferably 5 to 40 wt %, and in particular, 7.5 to 30 wt %, based in each case on the weight of the washing or cleaning agent, is particularly preferred. Agents that contain, based on the weight of the washing or cleaning agent, less than 20 wt %, by preference less than 17 wt %, preferably less than 13 wt %, and in particular, less than 9 wt % carbonate(s) and/or hydrogencarbonate(s), preferably alkali carbonate(s), particularly preferably sodium carbonate, are particularly preferred.

Organic co-builders that may be mentioned are in particular, polycarboxylates/polycarboxylic acids, polymeric polycarboxylates, aspartic acid, polyacetals, dextrins, further organic co-builders, and phosphonates. These substance classes are described below.

Usable organic builder substances are, for example, the polycarboxylic acids usable in the form of their sodium salts, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. Preferred salts are the salts of the polycarboxylic acids such as citric acid, adipic acid, succinic acid, glutaric acid, tartaric acid, sugar acids, and mixtures thereof.

The acids per se can also be used. The acids typically also possess, in addition to their builder effect, the property of an acidifying component, and thus serve also to establish a lower and milder pH for washing or cleaning agents. Worthy of mention in this context are, in particular, citric acid, succinic acid, glutaric acid, adipic acid, gluconic acid, and any mixtures thereof.

Further suitable as builders are polymeric polycarboxylates; these are, for example, the alkali-metal salts of polyacrylic acid or polymethacrylic acid, for example, those having a relative molecular weight of 500 to 70,000 g/mol.

The molar weights indicated for the polymeric polycarboxylates are, for purposes of this document, weight-averaged molar weights M_{w} of the respective acid form that were determined in principle by means of gel permeation chromatography (GPC), a UV detector having been used. The measurement was performed against an external polyacrylic acid standard that, because of its structural affinity with the polymers being investigated, yielded realistic molecular weight values. These indications deviate considerably from the molecular weight indications in which polystyrenesulfonic acids are used as the standard. The molar weights measured against polystyrenesulfonic acids are usually much higher than the molar weights indicated in this document.

Suitable polymers are, in particular, polyacrylates that preferably have a molecular weight from 2,000 to 20,000 g/mol. Because of their superior solubility, of this group the short-chain polyacrylates that have molar weights from 2,000 to 10,000 g/ml, and particularly preferably from 3,000 to 5,000 g/mol, may in turn be preferred.

Copolymeric polycarboxylates, in particular, those of acrylic acid with methacrylic acid or of acrylic acid or methacrylic acid with maleic acid, are also suitable. Copolymers of acrylic acid with maleic acid that contain 50 to 90 wt % acrylic acid and 50 to 10 wt % maleic acid have proven particularly suitable. Their relative molecular weight, based on free acids, is generally 2,000 to 70,000 g/mol, preferably 20,000 to 50,000 g/mol, and in particular, 30,000 to 40,000 g/mol.

The (co)polymeric polycarboxylates can be used as either a powder or an aqueous solution. The (co)polymeric polycarboxylate content of the washing and/or cleaning agents is preferably 0.5 to 20 wt %, in particular, 3 to 10 wt %.

To improve water solubility, the polymers can also contain allylsulfonic acids, for example, allyloxybenzenesulfonic acid and methallylsulfonic acid, as monomers.

Also particularly preferred are biodegradable polymers made up of more than two different monomer units, for example, those that contain salts of acrylic acid and of maleic acid, as well as vinyl alcohol or vinyl alcohol derivatives, as monomers, or that contain salts of acrylic acid and of 2-alkylallylsulfonic acid, as well as sugar derivatives, as monomers.

Further preferred copolymers are those that have, as monomers, preferably acrolein and acrylic acid/acrylic acid salts, or acrolein and vinyl acetate.

Also to be mentioned as further preferred builder substances are polymeric aminodicarboxylic acids, their salts, or their precursor substances. Polyaspartic acids and their salts are particularly preferred.

Other suitable builder substances are polyacetals, which can be obtained by reacting dialdehydes with polyolcarboxylic acids that have 5 to 7 carbon atoms and at least 3 hydroxyl groups. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Other suitable organic builder substances are dextrins, for example, oligomers or polymers of carbohydrates, which can be obtained by partial hydrolysis of starches. The hydrolysis can be performed in accordance with usual, e.g., acid- or enzyme-catalyzed, methods. Preferably these are hydrolysis products having average molar weights in the range from 400 to 500,000 g/mol. A polysaccharide having a dextrose equivalent (DE) in the range from 0.5 to 40, in particular, from 2 to 30, is preferred, DE being a common indicator of the reducing effect of a polysaccharide as compared with dextrose, which possesses a DE of 100.

Both maltodextrins having a DE between 3 and 20 and dry glucose syrups having a DE between 20 and 37, and so-called yellow dextrins and white dextrins having higher molar weights in the range from 2,000 to 30,000 g/mol, are usable. The oxidized derivatives of such dextrins are their reaction products with oxidizing agents that are capable of oxidizing at least one alcohol function of the saccharide ring to the carboxylic acid function.

Oxydisuccinates and other derivatives of disuccinates, preferably ethylenediamine disuccinate, are also additional suitable co-builders Ethylenediamine N,N′-disuccinate (EDDS) is used preferably in the form of its sodium or magnesium salts. Also preferred in this context are glycerol disuccinates and glycerol trisuccinates. Suitable utilization quantities in zeolite-containing and/or silicate-containing formulations are 3 to 15 wt %.

Other usable organic co-builders are, for example, acetylated hydroxycarboxylic acids and their salts, which can optionally also be present in lactone form and which contain at least 4 carbon atoms and at least one hydroxy group, as well as a maximum of two acid groups.

All compounds that are capable of forming complexes with alkaline-earth ions can also be used as co-builders.

### Surfactants.

The group of the surfactants includes the nonionic, anionic, cationic, and amphoteric surfactants.

All nonionic surfactants known to one skilled in the art can be used as nonionic surfactants. Low-foaming nonionic surfactants are used as preferred surfactants. With particular preference, washing or cleaning agents, in particular, cleaning agents for automatic dishwashing, contain nonionic surfactants, in particular, nonionic surfactants from the group of the alkoxylated alcohols. The nonionic surfactants used are preferably alkoxylated, advantageously ethoxylated, in particular, primary alcohols having preferably 8 to 18 C atoms and an average of 1 to 12 mol ethylene oxide (EO) per mol of alcohol, in which the alcohol radical can be linear or preferably methyl-branched in the 2-position, or can contain mixed linear and methyl-branched radicals, such as those that are usually present in oxo alcohol radicals. Particularly preferred, however, are alcohol ethoxylates having linear radicals made up of alcohols of natural origin having 12 to 18 carbon atoms, e.g., from coconut, palm, tallow, or oleyl alcohol, and an average of 2 to 8 EO per mol of alcohol. The preferred ethoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can be an integral or fractional number for a specific product. Preferred alcohol ethoxylates exhibit a narrow distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO.

Also usable as further nonionic surfactants are alkyl glycosides of the general formula RO(G)ₓ, in which R denotes a primary straight-chain or methyl-branched (in particular, methyl-branched in the 2-position) aliphatic radical having 8 to 22, preferably 12 to 18 carbon atoms; and G is the symbol denoting a glycose unit having 5 or 6 carbon atoms, preferably glucose. The degree of oligomerization x, which indicates the distribution of monoglycosides and oligoglycosides, is any number between 1 and 10; preferably x is between 1.2 and 1.4.

A further class of nonionic surfactants used in preferred fashion, which are used either as the only nonionic surfactant or in combination with other nonionic surfactants, is alkoxylated, preferably ethoxylated or ethoxylated and propoxylated, fatty acid alkyl esters, preferably having 1 to 4 carbon atoms in the alkyl chain.

Nonionic surfactants of the amine oxide type, for example, N-cocoalkyl-N,N-dimethylamine oxide and N-tallowalkyl-N,N-dihydroxyethylamine oxide, and the fatty acid alkanolamides, can also be suitable. The quantity of these nonionic surfactants is preferably no more than that of the ethoxylated fatty alcohols, in particular, no more than half thereof.

Further suitable surfactants are polyhydroxy fatty acid amides of the following formula:

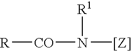

in which R denotes an aliphatic acyl radical having 6 to 22 carbon atoms; R¹ denotes hydrogen, an alkyl or hydroxyalkyl radical having 1 to 4 carbon atoms; and [Z] denotes a linear or branched polyhydroxyalkyl radical having 3 to 10 carbon atoms and 3 to 10 hydroxyl groups. The polyhydroxy fatty acid amides are known substances that can usually be obtained by reductive amination of a reducing sugar with ammonia, an alkylamine, or an alkanolamine, and subsequent acylation with a fatty acid, a fatty acid alkyl ester, or a fatty acid chloride.

Also belonging to the group of the polyhydroxy fatty acid amides are compounds of the following formula

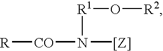

in which R denotes a linear or branched alkyl or alkenyl radical having 7 to 12 carbon atoms; R¹ denotes a linear, branched, or cyclic alkyl radical or an aryl radical having 2 to 8 carbon atoms; and R² denotes a linear, branched, or cyclic alkyl radical or an aryl radical or an oxyalkyl radical having 1 to 8 carbon atoms, C₁₋₄ alkyl or phenyl radicals being preferred; and [Z] denotes a linear polyhydroxyalkyl radical whose alkyl chain is substituted with at least two hydroxyl groups, or alkoxylated, preferably ethoxylated or propoxylated, derivatives of that radical

[Z] is preferably obtained by reductive amination of a sugar, for example, glucose, fructose, maltose, lactose, galactose, nannose, or xylose. The N-alkoxy- or N-aryloxy-substituted compounds can be converted into the desired polyhydroxy fatty acid amides by reaction with fatty acid methyl esters in the presence of an alkoxide as catalyst.

With particular preference, furthermore, surfactants that contain one or more tallow fatty alcohols with 20 to 30 EO, in combination with a silicone defoamer, are used.

Nonionic surfactants from the group of the alkoxylated alcohols, particularly preferably from the group of the mixed alkoxylated alcohols and in particular from the group of the EO-AO-EO nonionic surfactants, are likewise used with particular preference.

Nonionic surfactants that have a melting point above room temperature are preferred in particular, nonionic surfactant(s) having a melting point above 20° C., preferably above 25° C., particularly preferably between 25 and 60° C., and in particular, between 26.6 and 43.3° C., is/are particularly preferred.

Suitable nonionic surfactants that exhibit melting or softening points in the aforesaid temperature range are, for example, low-foaming nonionic surfactants that can be solid or highly viscous at room temperature. If nonionic surfactants that are highly viscous at room temperature are used, it is preferred for them to exhibit a viscosity greater than 20 Pa·s, preferably greater than 35 Pa·s, and in particular, greater than 40 Pa·s. Nonionic surfactants that possess a waxy consistency at room temperature are also preferred.

Nonionic surfactants that are solid at room temperature and are preferred for use derive from the groups of the alkoxylated nonionic surfactants, in particular, the ethoxylated primary alcohols, and mixtures of these surfactants with structurally more complex surfactants such as polyoxypropylene/polyoxyethylene/polyoxypropylene (PO/EO/PO) surfactants. Such PO/EO/PO nonionic surfactants are moreover characterized by good foam control.

In a preferred embodiment of the present invention, the nonionic surfactant having a melting point above room temperature is an ethoxylated nonionic surfactant that has resulted from the reaction of a monohydroxyalkanol or alkylphenol having 6 to 20 carbon atoms with preferably at least 12 mol, particularly preferably at least 15 mol, in particular, at least 20 mol, of ethylene oxide per mol of alcohol or alkylphenol.

A particularly preferred nonionic surfactant that is solid at room temperature is obtained from a straight-chain fatty alcohol having 16 to 20 carbon atoms (C₁₆₋₂₀ alcohol), preferably a C₁₈ alcohol, and at least 12 mol, preferably at least 15 mol, and in particular, at least 20 mol of ethylene oxide. Of these, the so-called “narrow range ethoxylates” (see above) are particularly preferred.

It is therefore particularly preferred to use ethoxylated nonionic surfactants that were obtained from C₆₋₂₀ alkylphenols or C₁₆₋₂₀ fatty alcohols and more than 12 mol, preferably more than 15 mol, and in particular, more than 20 mol ethylene oxide per mol of alcohol.

The nonionic surfactant that is solid at room temperature preferably additionally possesses propylene oxide units in the molecule. Such PO units preferably constitute up to 25 wt %, particularly preferably up to 20 wt %, and in particular, up to 15 wt % of the total molar weight of the nonionic surfactant. Particularly preferred nonionic surfactants are ethoxylated monohydroxyalkanols or alkylphenols that additionally comprise polyoxyethylene-polyoxypropylene block copolymer units. The alcohol or alkylphenol portion of such nonionic surfactant molecules preferably makes up more than 30 wt %, particularly preferably more than 50 wt %, and in particular, more than 70 wt % of the total molar weight of such nonionic surfactants. Preferred agents are characterized in that they contain ethoxylated and propoxylated nonionic surfactants in which the propylene oxide units in the molecule constitute up to 25 wt %, preferably up to 20 wt %, and in particular, up to 15 wt % of the total molar weight of the nonionic surfactant.

Additional nonionic surfactants having melting points above room temperature that are particularly preferred for use contain 40 to 70% of a polyoxypropylene/polyoxyethylene/polyoxypropylene block polymer blend that contains 75 wt % of a reverse block copolymer of polyoxyethylene and polyoxypropylene having 17 mol ethylene oxide and 44 mol propylene oxide, and 25 wt % of a block copolymer of polyoxyethylene and polyoxypropylene, initiated with trimethylolpropane and containing 24 mol ethylene oxide and 99 mol propylene oxide per mol of trimethylolpropane.

Nonionic surfactants that can be used with particular preference are obtainable, for example, from Olin Chemicals under the name Poly Tergent® SLF-18.

Surfactants of the formula

R¹O[CH₂CH(CH₃)O][CH₂CH₂O]_{y}CH₂CH(OH)R²,

in which R¹ denotes a linear or branched aliphatic hydrocarbon radical having 4 to 18 carbon atoms or mixtures thereof, R² denotes a linear or branched hydrocarbon radical having 2 to 26 carbon atoms or mixtures thereof, and x denotes values between 0.5 and 1.5 and y a value of at least 15, are additional particularly preferred nonionic surfactants.

Additional nonionic surfactants preferred for use are the end-capped poly(oxyalkylated) surfactants of the formula

R¹O[CH₂CH(R³)O]ₓ[CH₂]ₖCH(OH)[CH₂]ⱼOR²,

in which R¹ and R² denote linear or branched, saturated or unsaturated, aliphatic or aromatic hydrocarbon radicals having 1 to 30 carbon atoms: R denotes H or a methyl, ethyl, n-propyl, isopropyl, n-butyl, 2-butyl, or 2-methyl-2-butyl radical; x denotes values between 1 and 30; and k and j denote values between 1 and 12, preferably between 1 and 5. If the value of x is greater than or equal to 2, each R³ in the above formula R¹O[CH₂CH(R³)O]ₓ[CH₂]ₖCH(OH)[CH₂]ⱼOR² can be different. R¹ and R² are preferably linear or branched, saturated or unsaturated, aliphatic or aromatic hydrocarbon radicals having 6 to 22 carbon atoms, radicals having 8 to 18 carbon atoms being particularly preferred. For the R³ radical, H, —CH₃, or CH₂CH₃ are particularly preferred. Particularly preferred values for x are in the range from 1 to 20, in particular, from 6 to 15.

As described above, each R³ in the formula above can be different if x≧2. The alkylene oxide unit in the square brackets can thereby be varied. If, for example, x denotes 3, the R³ radical can be selected so as to form ethylene oxide (R³=H) or propylene oxide (R³=CH₃) units, which can be joined to one another in any sequence, for example, (EO)(PO)(EO), (EO)(EO)(PO), (EO)(EO)(EO), (PO)(EO)(PO), (PO)(PO)(EO), and (PO)(PO)(PO). The value of 3 for x was selected as an example here, and can certainly be larger; the range of variation increases with rising values of x, and includes e.g., a large number of (EO) groups combined with a small number of (PO) groups, or vice versa.

Particularly preferred end-group-terminated poly(oxyalkylated) alcohols of the above formula have values of k=1 and j=1, so that the formula above is simplified to

R¹O[CH₂CH(R³)O]ₓCH₂CH(OH)CH₂OR²

In the latter formula, R¹, R², and R³ are as defined above, and x denotes numbers from 1 to 30, preferably from 1 to 20, and in particular, from 6 to 18. Surfactants in which the R¹ and R² radicals have 9 to 14 carbon atoms, R³ denotes H, and x assumes values from 6 to 15, are particularly preferred.

Summarizing what has just been stated, end-capped poly(oxyalkylated) nonionic surfactants of the formula

R¹O[CH₂CH(R³)O]ₓ[CH₂]ₖCH(OH)[CH₂]ⱼOR²,

in which R¹ and R³ denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30, and k and j denote values between 1 and 12, preferably between 1 and 5, are preferred, surfactants of the following type:

R¹O[CH₂CH(R³)O]ₓCH₂CH(OH)CH₂OR²,

in which x denotes numbers from 1 to 30, preferably from 1 to 20, and in particular, from 6 to 18, being particularly preferred.

Low-foaming nonionic surfactants that comprise alternating ethylene-oxide and alkyleneoxide units have proven to be particularly preferred nonionic surfactants in the context of the present invention. Among these in turn, surfactants having EO-AO-EO-AO blocks are preferred, one to ten EO or AO groups being bound to one another in each case before being followed by a block of the respectively other groups. Preferred here are nonionic surfactants of the general formula

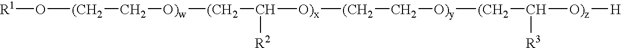

in which R¹ denotes a straight-chain or branched, saturated, or mono- or polyunsaturated CH₆₋₂₄ alkyl or alkenyl radical; each R² and R³ group, independently of one another, is selected from —CH₃, —CH₂CH₃, —CH₂CH₂—CH₃, CH(CH₃)₂; and the indices w, x, y, and z denote, independently of one another, integers from 1 to 6.

The preferred nonionic surfactants of the above formula can be produced, using known methods from the corresponding R¹—OH alcohols and ethylene or alkylene oxide. The R¹ radical in the above formula can vary depending on the derivation of the alcohol. If natural sources are used, the R¹ radical has an even number of carbon atoms and is generally unbranched, the linear radicals from alcohols of natural origin having 12 to 18 carbon atoms, e.g., from coconut, palm, tallow, or oleyl alcohol, being preferred. Alcohols accessible from synthetic sources are, for example, the Guerbet alcohols or radicals methyl-branched in the 2-position or mixed linear and methyl-branched radicals, such as those usually present in oxo alcohol radicals. Regardless of the nature of the alcohol used for production of the nonionic surfactants contained in the agents, nonionic surfactants in which R¹ in the above formula denotes an alkyl radical having 6 to 24, preferably 8 to 20, particularly preferably 9 to 15, and in particular, 9 to 11 carbon atoms, are preferred.

In addition to propylene oxide, butylene oxide in particular, is a possibility as an alkylene oxide unit that is contained, alternatingly with the ethylene oxide unit, in the preferred nonionic surfactants. Further alkylene oxides, in which R² and R³, independently of one another, are selected from —CH₂CH₂—CH₃ or CH(CH₃)₂, are, however also suitable. It is preferred to use nonionic surfactants of the above formula in which R² and R³ denote a —CH₃ radical; w and x, independently of one another, denote values of 3 or 4; and y and z, independently of one another, denote values of 1 or 2.

In summary, nonionic surfactants that comprise a C₉₋₁₅ alkyl radical having 1 to 4 ethylene oxide units, followed by 1 to 4 propylene oxide units, followed by 1 to 4 ethylene oxide units, followed by 1 to 4 propylene oxide units, are preferred in particular. These surfactants exhibit the necessary low viscosity in aqueous solution, and are usable with particular preference according to the present invention.

Additional nonionic surfactants that are usable in preferred fashion are the end-capped poly(oxyalkylated) nonionic surfactants of the formula

R¹O[CH₂CH(R³)O]ₓR²,

in which R¹ denotes linear or branched, saturated or unsaturated, aliphatic or aromatic hydrocarbon radicals having 1 to 30 carbon atoms; R² denotes linear or branched, saturated or unsaturated, aliphatic or aromatic hydrocarbon radicals having 1 to 30 carbon atoms, which preferably comprise between 1 and 5 hydroxy groups and preferably are further functionalized with an ether group; R³ denotes H or a methyl, ethyl, n-propyl, isopropyl, n-butyl, 2-butyl, or 2-methyl-2-butyl radical; and x denotes values between 1 and 40.

In a particularly preferred embodiment of the present application, R³ in the aforesaid general formula denotes H. From the group of the resulting end-capped poly(oxyalkylated) nonionic surfactants of the formula

R¹O[CH₂CH₂O]ₓR²

those nonionic surfactants in which R¹ denotes linear or branched, saturated or unsaturated, aliphatic or aromatic hydrocarbon radicals having 1 to 30 carbon atoms, preferably having 4 to 20 carbon atoms; R² denotes linear or branched, saturated or unsaturated, aliphatic or aromatic hydrocarbon radicals having 1 to 30 carbon atoms, which preferably comprise between 1 and 5 hydroxy groups; and x denotes values between 1 and 40, are particularly preferred.

Particularly preferred are those end-capped poly(oxyalkylated) nonionic surfactants that, in accordance with the formula

R¹O[CH₂CH₂O]ₓCH₂CH(OH)R²,

in addition to a radical R¹ that denotes linear or branched, saturated or unsaturated, aliphatic or aromatic hydrocarbon radicals having 1 to 30 carbon atoms, preferably having 4 to 20 carbon atoms, additionally comprise a linear or branched, saturated or unsaturated, aliphatic or aromatic hydrocarbon radical R² having 1 to 30 carbon atoms which is adjacent to a monohydroxylated intermediate group —CH₂CH(OH)—. In this formula, x denotes values between 1 and 90.

Particularly preferred are nonionic surfactants of the general formula

R¹O[CH₂CH₂O]ₓCH₂CH(OH)R²

in which, in addition to a radical R¹ that denotes linear or branched, saturated or unsaturated, aliphatic or aromatic hydrocarbon radicals having 1 to 30 carbon atoms, preferably having 4 to 22 carbon atoms, additionally comprise a linear or branched, saturated or unsaturated, aliphatic or aromatic hydrocarbon radical R² having 1 to 30 carbon atoms, preferably 2 to 22 carbon atoms, which is adjacent to a monohydroxylated intermediate group —CH₂CH(OH)— and in which x denotes values between 40 and 80, preferably values between 40 and 60.

The corresponding end-capped poly(oxyalkylated) nonionic surfactants of the above formula can be obtained, for example, by reacting an end-position epoxide of formula R²CH(O)CH₂ with an ethoxylated alcohol of formula R¹O[CH₂CH₂O]ₓ₋₁CH₂CH₂OH.

Particularly preferred, in addition, are those end-capped poly(oxyalkylated) nonionic surfactants of the formula

R¹O[CH₂CH₂O]ₓ[CH₂CH(CH₃)O]_{y}CH₂CH(OH)R²

in which R¹ and R², independently of one another, denote a linear or branched, saturated or mono- or polyunsaturated hydrocarbon radical having 2 to 26 carbon atoms, R³ is selected, independently of one another, from CH₃—CH₂CH₃, —CH₂CH₂—CH₃, CH(CH₃)₂, but preferably denotes —CH₃, and x and y, independently of one another, denote values between 1 and 32, nonionic surfactants having values for x of 15 to 32 and for y of 0.5 and 1.5 being very particularly preferred.

Surfactants of the general formula

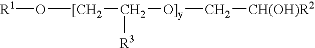

in which R¹ and R², independently of one another, denote a linear or branched, saturated or mono- or polyunsaturated hydrocarbon radical having 2 to 26 carbon atoms, R³ is selected, independently of one another, from CH₃—CH₂CH₃, —CH₂CH₂—CH₃, CH(CH₃)₂, but preferably denotes —CH₃, and x and y, independently of one another, denote values between 1 and 32, are preferred according to the present invention, nonionic surfactants having values for x from 15 to 32 and for y of 0.5 and 1.5 being very particularly preferred.

The carbon chain lengths, degrees of ethoxylation, and degrees of alkoxylation indicated for the aforesaid nonionic surfactants represent statistical averages that may be an integer or a fractional number for a specific product. As a result of production methods, commercial products of the aforesaid formulas are usually made up not of an individual representative, but rather of mixtures so that average values and, as a consequence, fractional numbers can result both for the carbon chain lengths and for the degrees of ethoxylation and degrees of alkoxylation.

The aforesaid nonionic surfactants can of course be used not only as individual substances, but also as surfactant mixtures made up of two, three, four, or more surfactants. “Surfactant mixtures” refers not to mixtures of nonionic surfactants that fall in their totality, under one of the aforesaid general formulas, but instead to those mixtures containing two, three, four, or more nonionic surfactants that can be described by different ones of the aforesaid general formulas.

Anionic surfactants that can be used are, for example, those of the sulfonate and sulfate types. Possibilities as surfactants of the sulfonate type are, preferably, C₉₋₁₃ alkyl benzenesulfonates, olefinsulfonates, i.e., mixtures of alkene and hydroxyalkanesulfonates, and disulfonates, for example, such as those obtained from C₁₂₋₁₈ monoolefins having an end-located or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example, by sulfochlorination or sulfoxidation with subsequent hydrolysis and neutralization. The esters of α-sulfo fatty acids (estersulfonates), e.g., the α-sulfonated methyl esters of hydrogenated coconut, palm kernel, or tallow fatty acids, are likewise suitable.

Further suitable anionic surfactants are sulfonated fatty acid glycerol esters. “Fatty acid glycerol esters” are understood as the mono-, di- and triesters, and mixtures thereof, that are obtained during the production by esterification of a monoglycerol with 1 to 3 mol fatty acid, or upon transesterification of triglycerides with 0.3 to 2 mol glycerol. Preferred sulfonated fatty acid glycerol esters are the sulfonation products of saturated fatty acids having 6 to 22 carton atoms, for example, hexanoic acid, octanoic acid, decanoic acid, myristic acid, lauric acid, palmitic acid, stearic acid, or behenic acid.

Preferred alk(en)yl sulfates are the alkali, and in particular, sodium, salts of the sulfuric acid semi-esters of the C₁₂-C₁₈ fatty alcohols, for example, from coconut fatty alcohol, tallow fatty alcohol, lauryl, myristyl, cetyl, or stearyl alcohol, or the C₁₀-C₂₀ oxo alcohols and those semi-esters of secondary alcohols of those chain lengths. Additionally preferred are alk(en)yl sulfates of the aforesaid chain length that contain a synthetic straight-chain alkyl radical produced on a petrochemical basis, which possess a breakdown behavior analogous to those appropriate compounds based on fat-chemistry raw materials. For purposes of washing technology, the C₁₂-C₁₆ alkyl sulfates and C₁₂₋₁₅ alkyl sulfates, as well as C₁₄-C₁₅ alkyl sulfates, are preferred. 2,3-alkyl sulfates that can be obtained as commercial products of the Shell Oil Company, under the name DAN® are also suitable anionic surfactants.

The sulfuric acid monoesters of straight-chain or branched C₇₋₂₁ alcohols ethoxylated with 1 to 6 mol ethylene oxide such as 2-methyl-branched C₉₋₁₁ alcohols with an average of 3.5 mol ethylene oxide (EO) or C₁₂₋₁₈ fatty alcohols with 1 to 4 EO, are also suitable. Because of their high foaming characteristics they are used in cleaning agents only in relatively small quantities, for example, in quantities from 1 to 5 wt.

Other suitable anionic surfactants are also the salts of alkylsulfosuccinic acid, which are also referred to as sulfosuccinates or as sulfosuccinic acid esters and represent the monoesters and/or diesters of sulfosuccinic acid with alcohols, preferably fatty alcohols, and in particular, ethoxylated fatty alcohols. Preferred sulfosuccinates contain C₈₋₁₈ fatty alcohol radicals or mixtures thereof. Particularly preferred sulfosuccinates contain a fatty alcohol radical that is derived from ethoxylated fatty alcohols which, considered per se, represent nonionic surfactants. Sulfosuccinates whose fatty alcohol radicals derive from ethoxylated fatty alcohols with a restricted homolog distribution are, in turn, particularly preferred. It is likewise also possible to use alk(en)ylsuccinic acid having preferably 8 to 18 carbon atoms in the alk(en)yl chain, or salts thereof.

Further appropriate anionic surfactants are, in particular, soaps. Saturated fatty acid soaps, such as the salts of lauric acid, myristic acid, palmitic acid, stearic acid, hydrogenated erucic acid, and behenic acid, are suitable, as are soap mixtures derived in particular, from natural fatty acids, e.g., coconut, palm kernel, or tallow fatty acids.

The anionic surfactants, including the soaps, can be present in the form of their sodium, potassium, or ammonium salts, and as soluble salts of organic bases, such as mono-, di-, or triethanolamine. The anionic surfactants are preferably present in the form of their sodium or potassium salts in particular, in the form of the sodium salts.

If the anionic surfactants are a constituent of automatic dishwashing agents, their content is by preference less than 4 wt %, preferably less than 2 wt %, and very particularly preferably less than 1 wt %. Automatic dishwashing a-gents that contain no anionic surfactants are particularly preferred.

Instead of the aforesaid surfactants or in combination with them, cationic and/or amphoteric surfactants can also be used.

Cationic compounds that can be used, for example, as cationic active substances are of the following formulas:

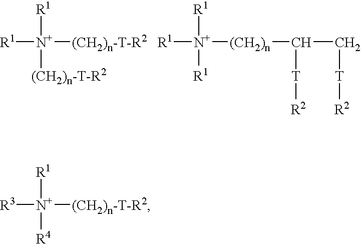

in which each R¹ group, independently of one another, is selected from C₁₋₆ alkyl, alkenyl, or hydroxyalkyl groups; each R² group independently of one another, is selected from C₈₋₂₈ alkyl or alkenyl groups: R³═R¹ or (CH₂)ₙ-T-R²; R⁴=R¹ or R² or (CH₂)ₙ-T-R²; T==CH₂—, —O—CO— or —CO—O— and n is an integer from 0 to 5.

In automatic dishwashing agents, the cationic and/or amphoteric surfactant content is by preference less than 6 wt %, preferably less than 4 wt %, very particularly preferably less than 2 wt %, and in particular, less than 1 wt %. Automatic dishwashing agents that contain no cationic or amphoteric surfactants are particularly preferred.

### Polymers

The group of the polymers includes, in particular, the polymers having washing or cleaning activity, for example, the clear rinsing polymers and/or polymers active as softeners. In general, in addition to nonionic polymers, cationic, anionic, and amphoteric polymers are also usable in washing or cleaning agents.

“Cationic polymers” for purposes of the present invention are polymers that carry a positive charge in the polymer molecule. This can be implemented, for example, by way of (alkyl)ammonium groupings or other positively charged groups present in the polymer chain. Particularly preferred cationic polymers derive from the groups of the quaternized cellulose derivatives, the polysiloxanes having quaternary groups, the cationic guar derivatives, the polymeric dimethyldiallylammonium salts and their copolymers with esters and amides of acrylic acid and methacrylic acid, the copolymers of vinylpyrrolidone with quaternized derivatives of dialkylaminoacrylate and -methacrylate, the vinylpyrrolidone/methoimid-azolinium chloride copolymers, the quaternized poly(vinylalcohols), or the polymers known by the INCI designations Polyquaternium 2, Polyquaternium 17, Polyquaternium 18, and Polyquaternium 27.

“Amphoteric polymers” for purposes of the present invention additionally comprise, in addition to a positively charged group in the polymer chain, negatively charged groups or monomer units. These groups can be, for example, carboxylic acids, sulfonic acids, or phosphonic acids.

Preferred washing or cleaning agents, in particular, preferred automatic dishwashing agents, are characterized in that they contain a polymer a) that comprises monomer units of the formula R¹R²C=CR³R⁴ in which each R¹, R², R³, R⁴ radical is selected, independently of one another, from hydrogen, a derivatized hydroxy group, C₁₋₃₀ linear or branched alkyl groups, aryl aryl-substituted C₁₋₃₀ linear or branched alkyl groups, polyalkoxylated alkyl groups, heteroatomic organic groups having at least one positive charge without charged nitrogen, at least one quaternized N atom or at least one amino group having a positive charge in the sub-range of the pH range from 2 to 11 or salts thereof, with the stipulation that at least one R¹, R², R³R⁴ radical is a heteroatomic organic grout having at least one positive charge without charged nitrogen, at least one quaternized N atom, or at least one amino group having a positive charge.

Cationic or amphoteric polymers that are particularly preferred in the context of the present application contain as a monomer unit a compound of the general formula

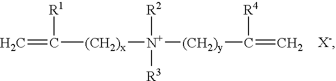

in which R¹ and R⁴, independently of one another, denote H or a linear or branched hydrocarbon radical having 1 to 6 carbon atoms; R² and R³, independently of one another, denote an alkyl, hydroxyalkyl, or aminoalkyl group in which the alkyl radical is linear or branched and comprises between 1 and 6 carbon atoms, this preferably being a methyl group; x and y, independently of one another, denote integers between 1 and 3; X represents a counterion, preferably a counterion from the group chloride, bromide, iodide, sulfate, hydrogensulfate, methosulfate, lauryl sulfate, dodecylbenzenesulfonate, p-toluenesulfonate (tosylate), cumenesulfonate, xylenesulfonate, phosphate, citrate, formate, acetate, or mixtures thereof.

Preferred R¹ and R⁴ radicals in the above formula are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH—OH, —CH₂CH(OH)—CH₃, CH(OH)—CH₂—CH₃, and —(CH₂CH₂—O)ₙH.

Very particularly preferred are polymers that comprise a cationic monomer unit of the above general formula in which R¹ and R⁴ denote H, R² and R³ denote methyl, and x and y are each 1. The corresponding monomer units of the formula

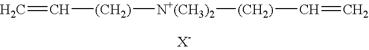

are also referred to in the case in which X-=chloride, as DADMAC (diallyldimethylammonium chloride).

Further cationic or amphoteric Polymers that are particularly preferred contain a monomer unit of the general formula

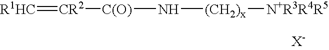

in which R¹, R², R³, R⁴ and R⁵, independently of one another, denote a linear or branched, saturated or unsaturated alkyl or hydroxyalkyl radical having 1 to 6 carbon atoms, preferably a linear or branched alkyl radical selected from —CH₃, —CH₂—CH₃, —CH₂—CH₂—CH₃, —CH(CH₃)—CH₃, —CH₂—OH, —CH₂—CH₂—OH, CH(OH)—CH₃, —CH₂—CH₂—CH₂—OH, —CH₂—CH(OH)—CH₃, —CH(OH)—CH₃, and —(CH₂CH₂—O)ₙH, and x denotes a whole number between 1 and 6.

Very particularly preferred in the context of the present application are Polymers that comprise a cationic monomer unit of the above general formula in which R¹ denotes H and R³, R⁴ and R⁵ denote methyl and x denotes 3. The corresponding monomer units of the formula

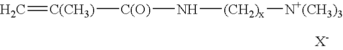

are also referred to, in the case where X=chloride, as MAPTAC (methyacryamidopropyltrimethylammonium chloride).

Polymers that contain, as monomer units, diallyldimethylammonium salts and/or acrylamidopropyltrimethylammonium salts are preferred according to the present invention.

The aforementioned amphoteric polymers comprise not only cationic groups but also anionic groups or monomer units Anionic monomer units of this kind derive, for example, from the group of the linear or branched, saturated or unsaturated carboxylates, the linear or branched, saturated or unsaturated phosphonates, the linear or branched, saturated or unsaturated sulfates, or the linear or branched, saturated or unsaturated sulfonates. Preferred monomer units are acrylic acid, (meth)acrylic acid, (dimethyl)acrylic acid, (ethyl)acrylic acid, cyanoacrylic acid, vinylacetic acid, allylacetic acid, crotonic acid, maleic acid, fumaric acid, cinnamic acid, and their derivatives, the allylsulfonic acids such as, for example, allyloxybenzenesulfonic acid and methallylsulfonic acid, or the allylphosphonic acids.

Amphoteric polymers preferred for use derive from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl methylacrylic acid copolymers, the alkylacrylamide/methylmethacrylic acid/alkylaminoalkyl(meth) acrylic acid copolymers, the alkylacrylamide/alkylmethacrylate/alkylaminoethylmethacrylate/alkylmethacrylate copolymers, and the copolymers of unsaturated carboxylic adds, cationically derivatized unsaturated carboxylic acids and, if applicable, further ionic or nonionogenic monomers.

Zwitterionic Polymers preferred for use derive from the group of the acrylamidoalkyltrialkylammonium chloride/acrylic acid copolymers and their alkali and ammonium salts, the acrylamidoalkyltrialkylammonium chloride/methacrylic acid copolymers and their alkali and ammonium salts, and the methacroylethylbetaine/methacrylate copolymers.

Also preferred are amphoteric polymers that encompass, in addition to one or more anionic monomers, methacrylamidoalkyltrialkylammonium chloride and dimethyl(diallyl)ammonium chloride as cationic monomers.

Particularly preferred amphoteric polymers derive from the group of the methacrylamidoalkyltrialkylammonium chloride/dimethyl(diallyl)ammonium chloride/acrylic acid copolymers, the methacrylamidoalkyltrialkylammonium chloride/dimethyl(diallyl)ammonium chloride/methacrylic acid copolymers, and the methacrylamidoalkyltrialkylammonium chloride/dimethyl(diallyl ammonium chloride/alkyl(meth)acrylic acid copolymers, as well as their alkali and ammonium salts.

Particularly preferred are amphoteric polymers from the group of the methacrylamidopropyltrimethylammonium chloride/dimethyl(diallyl)ammonium chloride/acrylic acid copolymers, the methacrylaidopropyltrimethylammonium chloride/dimethyl(diallyl)ammonium chloride/acrylic acid copolymers, and the methacrylamidopropyltrimethylammonium chloride/dimethyl(diallyl)ammonium chloride/alkyl(meth)acrylic acid copolymers, as well as their alkali and ammonium salts.

In a particularly preferred embodiment of the present invention, the polymers are present in prepackaged form. Suitable for packaging of the polymers are, among others:
encapsulation of the polymers by means of water-soluble or water-dispersible coating agents, preferably by means of water-soluble or water-dispersible natural or synthetic polymers;
encapsulation of the polymers by means of water-insoluble meltable coating agents, preferably by means of water-insoluble coating agents from the group of the waxes or paraffins having a melting point above 30° C.;
co-granulation of the polymers with inert carrier materials, preferably with carrier materials from the group of the substances having washing or cleaning activity, particularly preferably from the group of the builders or co-builders.

Washing or cleaning agents contain the aforesaid cationic and/or amphoteric polymers preferably in quantities between 0.01 and 10 wt %, based in each case on the total weight of the washing or cleaning agent. Those washing or cleaning agents in which the weight proportion of the cationic and/or amphoteric polymers is between 0.01 and 8 wt %, by preference between 0.01 and 6 wt %, preferably between 0.01 and 4 wt %, particularly preferably between 0.01 and 2 wt %, and in particular, between 0.01 and 1 wt %, based in each case on the total weight of the automatic dishwashing agent, are, however, preferred in the context of the present application.

Polymers effective as softeners are, for example, the sulfonic acid group-containing polymers, which are used with particular preference.

Particularly preferred for use as sulfonic acid group-containing polymers are copolymers of unsaturated carboxylic acids, sulfonic acid group-containing monomers, and optionally further ionic or nonionogenic monomers.

Preferred as monomers in the context of the present invention are unsaturated carboxylic acids of the formula

R¹(R²)C=C(R³)COOH

in which R¹ to R³ independently of one another, denote —H —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals substituted with —NH₂, —OH, or —COOH, or denote —COOH or —COOR⁴, R⁴ being a saturated or unsaturated, straight-chain or branched hydrocarbon radical having 1 to 12 carbon atoms.

Among the unsaturated carboxylic acids that can be described by the above formula, acrylic acid (R¹=R²=R³=H), methacrylic acid (R¹=R²═H; R³═CH₃) and/or maleic acid (R¹═COOH; R²═R³=H) are particularly preferred.

Preferred in the context of the sulfonic acid group-containing monomers are those of the formula

R⁵(R⁶)C=C(R⁷)—X—SO₃H

in which R⁵ to R⁷, independently of one another, denote —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals substituted with —NH₂—OH, or —COOH, or denote —COOH or —COOR⁴, R⁴ being a saturated or unsaturated, straight-chain or branched hydrocarbon radical having 1 to 12 carbon atoms, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—.

Among these monomers, those of the formulas

H₂C=CH—X—SO₃H

H₂C=C(CH₃)—X—SO₃H

HO₃S—X—(R⁶)C=C(R⁷)—X—SO₃H

in which R⁶ and R⁷ independent of one another, are selected from —H, —CH₃, —CH₂CH₃, —CH₂CH₂CH₃, —CH(CH₃)₂ and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propane-1-sulfonic acid, styrenesulfonic acid, vinylsulfonic acid, 3-sulfopropylacrylate, 3-sulfopropylmethacrylate, sulfomethacrylamide, sulfomethylmethacrylamide, and water-soluble salts of the aforesaid acids.

Ethylenically unsaturated compounds, in particular, are suitable as further ionic or non nonionogenic monomers. The concentration of these further ionogenic or nonionogenic monomers in the polymers that are used according to the present invention is preferably less than 20 wt % based on the polymer. Polymers to be used in particularly preferred fashion comprise only monomers of the formula R¹(R²)C=C(R³)COOH and monomers of the formula R⁵(R⁶)=C(R⁷)—X—SO₃H.

In summary, copolymers of

i) unsaturated carboxylic acids of the formula R¹(R²)C=C(R³)COOH in which R¹ to R³, independently one another denote —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms,

ii) sulfonic acid group-containing monomers of the formula R⁵(R⁶)C═C(R⁷)—X—SO₃H

in which R⁵ to R⁷, independently of one another, denote —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturate or unsaturated, straight-chain or branched hydrocarbon radical having 1 to 12 carbon atoms; and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—,

iii) if applicable, further ionic or nonionogenic monomers,

are particularly preferred.

Further particularly preferred copolymers are made up of

i) one or more unsaturated carboxylic acids from the group of acrylic acid, methacrylic acid, and/or maleic acid,

ii) one or more sulfonic acid group-containing monomers of the formulas:

H₂C=CH—X—SO₃H

H₂C=C(CH₃)—X—SO₃H

HO₃S—X—(R⁶)C=C(R⁷)—X—SO₃H

in which R⁶ and R⁷, are selected, independently of one another from —H, —CH₃, —CH₂CH₃, —CH₂—CH₂CH₃, —CH(CH₃)₂, and X denotes an optionally present spacer group that is selected from —CH₂)ₙ— where n=0 to 4, —COO—(CH₂)ₖ— where k=1 to 6, —C(O)—NH—C(CH₃)₂—, and —C(O)—NH—CH(CH₂CH₃)—,

iii) if applicable, further ionic or nonionogenic monomers.

The copolymers can contain the monomers from groups i) and ii), and if applicable iii), in varying quantities, in which context all representatives of group i) can be combined with all representatives of group ii) and all representatives of group iii). Particularly preferred polymers exhibit certain structural units that are described below.

Copolymers that contain structural units of the formula

—[CH₂—CHCOOH]ₘ—[CH₂—CHC(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred, are, for example, preferred.

These polymers are produced by copolymerization of acrylic acid with a sulfonic acid group-containing acrylic acid derivative. If the sulfonic acid group-containing acrylic acid derivative is copolymerized with methacrylic acid, a different Polymer is arrived at, the use of which is likewise preferred. The corresponding copolymers contain structural units of the formula

—[CH₂—C(CH₃)COOH]ₘ—[CH₂—CHC(O)—Y—SO₃H]ₙ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n 0 to 4, —O—(C₆H₄)—, —NH—C(CH₃)₂—, or —NH—CH(CH₂CH₃)—, being preferred.

Entirely analogously, acrylic acid and/or methacrylic acid can also be copolymerized with sulfonic acid group-containing methacrylic acid derivatives, thereby modifying the structural units in the molecule. Copolymers that contain structural units of the formula

—[CH₂—CHCOOH]ₘ—[CH₂—C(CH₃)C(O—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O(CH₂)N— where n=0 to 4, —O—(C₆H₄)—, —NH—C(CH₃)₂—, or —NH—CH(CH₂CH₃)— being preferred, are preferred in just the same fashion as copolymers that contain structural units of the formula

—[CH₂—C(CH₃)COOH]ₘ—[CH₂—C(CH₃)C(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—, being preferred.

Instead of acrylic acid and/or methacrylic acid or as a supplement thereto, maleic acid can also be used as a particularly preferred monomer of group i). This results in copolymers, preferred according to the present invention, that contain structural units of the formula

—[HOOCCH—CHCOOH]ₘ—[CH₂—CHC(O)—Y—SO₃H]ₚ—,

in which m and p each denote a natural integer between 1 and 2,000, and Y denotes a spacer group that is selected from substitute or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred. Further preferred according to the present invention are copolymers that contain structural units of the formula

—[HOOCCH—CHCOOH]ₘ—[CH₂—C(CH₃)C(O)—Y—SO₃H]ₚ—,

in which m and p each denote, a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ where n=0 to 4, —O—C₄—NH—C(CH₃)₂—, or NH—CH—(CH₂CH₃)—, being preferred.

In summary, those copolymers that contain structural units of the formulas

—[CH₂—CHCOOH]ₘ—[CH₂—CHC(O)—Y—SO₃H]ₚ—

—[CH₂—C(CH₃)COOH]ₘ—[CH₂—CHC(O)—Y—SO₃H]ₚ—,

—[CH₂—CHCOOH]ₘ—[CH₂—C(CH₃)C(O)—Y—SO₃H]ₚ—,

—[CH₂—C(CH₃)COOH]ₘ—[CH₂—C(CH₃)C(O)—Y—SO₃H]ₚ—,

—[HOOCCH—CHCOOH]ₘ—[CH₂—CHC(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—C₆H₄)—, —NH—C(CH₃)₂—, or —NH—CH(CH₂CH₃)—, being preferred, are preferred according to the present invention.

The sulfonic acid groups can be present in the polymers entirely or partially in neutralized form, i.e., the acid hydrogen atom of the sulfnic acid group can be exchanged, in some or all sulfonic acid groups, for metal ions, preferably alkali-metal ions, and in particular, sodium ions. The use of Partially or entirely neutralized sulfonic acid group-containing copolymers is preferred according to the present invention.

The monomer distribution of the copolymers that are preferred for use according to the present invention is, in the context of copolymers that contain only monomers from groups i) and ii), preferably 5 to 95 wt % respectively of i) and ii), particularly preferably 50 to 90 wt % of monomer from group i) and 10 to 50 wt % of monomer from group ii), based in each case on the polymer.

For terpolymers, those that contain 20 to 85 wt % monomer from group i), 10 to 60 wt % monomer from group ii), and 5 to 30 wt % monomer from group iii) are particularly preferred.

The molar weight of the sulfo-copolymers preferred for use according to the present invention can be varied in order to adapt the properties of the polymers to the desired application. Preferred washing or cleaning agents are characterized in that the copolymers have molar weights from 2,000 to 200,000 gmol⁻¹, Preferably from 4,000 to 25,000 gmol⁻¹, and in particular, from 5,000 to 15,000 gmol⁻¹.

### Bleaching Agents.

The bleaching agents are a substance having washing or cleaning activity that is used with particular preference. Among the compounds yielding H₂O₂ in water that serve as bleaching agents, sodium percarbonate, sodium perborate tetrahydrate, and sodium perborate monohydrate are of particular importance. Other usable bleaching agents are, for example, peroxypyrophosphates, citrate perhydrates, and peracid salts or peracids that yield H₂O₂, such as perbenzoates, peroxyphthalates, diperazelaic acid, phthaloimino peracid, or diperdodecanedioic acid.

Bleaching agents from the group of the organic bleaching agents can furthermore be used. Typical organic bleaching agents are the diacyl peroxides, for example, dibenzoyl peroxide. Further typical organic bleaching agents are the peroxy acids, the alkylperoxy acids and arylperoxy acids being mentioned in particular, as examples. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthaloimidoperoxycaproic acid [phthaloiminoperoxyhexanoic acid (PAP)], o-carboxybenzamidoperoxycaproic acid, N-nonenylamidoperadipic acid, and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic) acid can be used.

Substances that release chlorine or bromine can also be used as bleaching agents. To be considered among the suitable materials releasing chlorine or bromine are, for example, heterocyclic N-bromamides and N-chloramides, for example, trichloroisocyanuric acid, tribromoisocyanuric acid, dibromoisocyanuric acid, and/or dichloroisocyanuric acid (DICA) and/or their salts with cations such as potassium and sodium. Hydantoin compounds such as 1,3-dichloro-5,5-dimethylhydantoin are also suitable.

Washing or cleaning agents, in particular, automatic dishwashing agents, that contain 1 to 35 wt %, preferably 2.5 to 30 wt %, particularly preferably 3.5 to 20 wt %, and in particular, 5 to 15 wt % bleaching agent, preferably sodium percarbonate, are preferred according to the present invention.

The active oxygen content of the washing or cleaning agents, in particular, the automatic dishwashing agents, is preferably between 0.4 and 10 wt %, particularly preferably between 0.5 and 8 wt %, and in particular, between 0.6 and 5 wt %, based in each case on the total weight of the agent. Particularly preferred agents have an active oxygen content above 0.3 wt %, preferably above 0.7 wt %, particularly preferably above 0.8 wt %, and in particular, above 1.0 wt %. Bleach Activators,

Bleach activators are used in washing or cleaning agents for example, in order to achieve an improved bleaching effect when cleaning at temperatures of 60° C. and below. Compounds that, under perhydrolysis conditions, yield aliphatic peroxycarboxylic acids having preferably 1 to 10 C atoms, in particular, 2 to 4 C atoms, and/or optionally substituted perbenzoic acid, can be used as bleach activators. Substances that carry the O- and/or N-acyl groups having the aforesaid number of carbon atoms, and/or optionally substituted benzoyl groups, are suitable. Multiply acylated alkylenediamines, in particular, tetraacetylethylenediamine (TAED), acylated triazine derivatives, in particular, 1,5-diacetyl-2,2-dioxohexahydro-1,3,5-triazine (DADHT), acylated glycolurils, in particular, tetraacetyl glycoluril (TAGU), N-acylimides, in particular, N-nonanoyl succinimide (NOSI), acylated phenolsulfonates, in particular, n-nonanoyl or isononanoyl oxybenzenesulfonate (n- and iso-NOBS), carboxylic acid anhydrides, in particular, phthalic acid anhydride, acylated polyvalent alcohols, in particular, triacetin, ethylene glycol diacetate, and 2,5-diacetoxy-2,5-dihydrofuran, are preferred.

Further bleach activators used in preferred fashion in the context of the present application are compounds from the group of the cationic nitrites, in particular, cationic nitrites of the formula

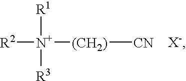

in which R¹ denotes —H, —CH₃, a C₂₋₂₄ alkyl or alkenyl radical, a substituted C₂₋₂₄ alkyl or alkenyl radical having at least one substituent from the group of —Cl, —Br, —OH, —NH₂, —CN, an alkyl or alkenylaryl radical having a C₁₋₂₄ alkyl group, or denotes a substituted alkyl or alkenylaryl radical having a C₁₋₂₄ alkyl group and at least one further substituent on the aromatic ring, R² and R³, independently of one another, are selected from —CH₂—CN, —CH₃, —CH₂CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH, where n=1, 2, 3, 4, 5 or 6; and X is an anion.

Particularly preferred is a cationic nitrite of the formula

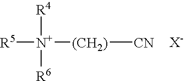

in which R⁴, R⁵ and R⁶ are selected, independently of one another, from —CH₃, —CH₂—CH₃, —CH₂—CH₂—CH₃, —CH(CH₃, where R⁴ can additionally also be —H; and X is an anion, such that preferably R⁵=R⁶=—CH₃ and in particular, R⁴=R⁵=R⁶=—CH₃, and compounds of the formulas (CH₃)₃N⁽⁺⁾CH₂—CNX⁻, (CH₃CH₂)₃N⁽⁺⁾CH₂—CNX⁻, (CH₃CH₂CH)₃N⁽⁺⁾CH₂—CNX⁻, (CH₃CH(CH₃))₃N⁽⁺⁾CH₂—CNX⁻, or (HO—CH₂—CH₂)₃N⁽⁺⁾CH₂—CNX⁻ are particularly preferred; of the group of these substances, the cationic nitrile of formula (CH₃)₃N⁽⁺⁾CH₂—CNX⁻, in which X⁻ denotes an anion that is selected from the group of chloride, bromide, iodide, hydrogensulfate, methosulfate, p-toluenesulfonate (tosylate), or xylenesulfonate, is in turn particularly preferred.

Compounds that, under perhydrolysis conditions, yield aliphatic peroxycarboxylic acids having preferably 1 to 10 C atoms, in particular, 2 to 4 C atoms, and/or optionally substituted perbenzoic acid, can additionally be used as bleach activators. Substances that carry the O- and/or N-acyl groups having the aforesaid number of C atom and/or optionally substituted benzoyl groups, are suitable. Multiply acylated alkylenediamines, in particular, tetraacetylethylendiamine (TAED), acylated triazine derivatives, in particular, 1,5-diacetyl-2,4-dioxohexahydro-1,3,5-triazine (DADHT), acylated glycolurils, in particular, tetraacetyl glycoluril (TAGU), N-acylimides, in particular, N-nonanoylsuccinimide (NOSI), acylated phenolsulfonates in particular, n-nonanoyl or isononanoyl oxybenzenesulfonate (n- or iso-NOBS), carboxylic acid anhydrides, in particular, phthalic acid anhydride, acylated polyvalent alcohols, in particular, triacetin, ethylene glycol diacetate, 2,5-diacetoxy-2,5-dihydrofuran, n-methylmorpholinium acetonitrile methyl sulfate (MMA), as well as acetylated sorbitol and mannitol and mixtures thereof (SORMAN), acylated sugar derivatives, in particular, pentaacetylglucose (PAG), pentaacetykfructose, tetraacetylxylose and octaacetyllactose, as well as acetylated, optionally N-alkylated glucamine and gluconolactone, and/or N-acylated lactams, for example, N-benzoylcaprolactam, are preferred. Hydrophilically substituted acyl acetates and acyl lactams are also used in preferred fashion. Combinations of conventional bleach activators can also be used.

If further bleach activators in addition to the nitrilquats are to be used, the bleach activators used are preferably those from the group of the multiply acylated alkylenediamines, in particular, tetraacetylethylendiamine (TAED), N-acylimides, in particular, N-nonanoylsuccinimide (NOSI), acylated phenolsulfonates, in particular, n-nonanoyl or isononanoyl oxybenzenesulfonate (n- or iso-NOBS), n-methylmorpholinium acetonitrile methyl sulfate (MMA), preferably in quantities up to 10 wt %, in particular, 0.1 wt % to 8 wt %, particularly 2 to 8 wt %, and particularly preferably 2 to 6 wt %, based in each case on the total weight of the bleach activator-containing agents.

In addition to or instead of the conventional bleach activators, so-called bleach catalysts can also be incorporated into the agents. These substances are bleach-intensifying transition-metal salts or transition-metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru ammine complexes, are also applicable as bleach catalysts.

Bleach-intensifying transition-metal complexes, in particular, having the central atoms Mn, Fe, Co, Cu, Mo, V, Ti, and/or Ru, preferably selected from the group of the manganese and/or cobalt salts and/or complexes, particularly preferably the cobalt(ammine) complexes, the cobalt(acetate) complexes, the cobalt(carbonyl) complexes, the chlorides of cobalt or manganese, and manganese sulfate, are used in usual quantities, preferably in a quantity up to 5 wt %, in particular, from 0.0025 wt % to 1 wt %, and particularly preferably from 0.01 wt % to 0.25 wt %, based in each case on the total weight of the bleach activator-containing agents. Even more bleach activator can, however, be used in specific cases.

### Enzymes.

Enzymes are usable in order to enhance the washing or cleaning performance of washing or cleaning agents. These include, in particular, proteases, amylases, lipases, hemicellulases, cellulases, or oxidoreductases, as well as preferably mixtures thereof. These enzymes are, in principle, of natural origin; improved variants based on the natural molecules are available for use in washing and cleaning agents and are correspondingly preferred for use. Washing or cleaning agents contain enzymes preferably in total quantities from 1×10⁻⁶ to 5 wt %, based on active protein. The Protein concentration can be determined with known methods, for example, the BCA method or the biuret method.

Among the proteases, those of the subtilisin type are preferred. Examples thereof are the subtilisins BPN′ and Carlsberg, protease PB92, subtilisins 147 and 309 the alkaline protease from Bacillus lentus, subtilisin DY, and the enzymes (to be classified, however, as subtilases and no longer as subtilisins in the strict sense) thermitase, proteinase K, and proteases TW3 and TW7. Subtilisin Carlsberg is obtainable in further developed form under the trade name Alcalase® from Novozymes A/S, Bagsvaerd, Denmark, Subtilisins 147 and 309 are marketed by Novozymes under the trade names Esperase® and Savinase®, respectively. The variants listed under the designation BLAP® are derive from the protease from Bacillus lentus DSM 5483.

Other usable proteases are, for example, the enzymes obtainable under the trade names Durazym®, Relase® Everlase®, Nafizym, Natalase®, Kannase®, and Ovozymes® from Novozymes, under the trade names Purafect®, Purafect® OxP and Properase® from Genencor, under the trade name Protosol® from Advanced Biochemicals Ltd., Thane, India, under the trade name Wuxi® from Wuxi Snyder Bioproducts Ltd., China, under the trade names Proleather® and Protease P® from Amano Pharmaceuticals Ltd., Nagoya, Japan, and under the designation Proteinase K-16 from Kao Corp., Tokyo, Japan.

Examples of amylases usable according to the present invention are the α-amylases from Bacillus licheniformis, from B. amyloliquefaciens, or from B. stearothermophilus, and their further developments improved for use in washing and cleaning agents. The enzyme from B. licheniformus is available from Novozymes under the name Termamyl® and from Genencor under the name Purastar® ST. Further developed products of this a-amylase are available from Novozymes under the trade names Duramyl® and Termamyl® ultra, from Genencor under the name Purastar® OxAm, and from Daiwa Seiko Inc., Tokyo Japan, as Keistase®. The α-amylase from B. amyloliquefaciens is marketed by Novozymes under the name BAN®, and derived variants of the α-amylase from B. stearothermophilus are marketed, again by Novozymes, under the names BSG® and Novamyl®.

Additionally to be highlighted for this purpose are the α-amylase from Bacillus sp, A 7-7 (DSM 12368) and the cyclodextrin-glucanotransferase (CGTase from B. agaradherens (DSM 9948).

The further developments of the α-amylase from Aspergillus niger and A. oryzae, obtainable from Novozymes under the trade names Fungamyl®, are also suitable. A further commercial product is, for example, Amylase-LT®.

Lipases or cutinases are additionally usable according to the present invention, in particular, because of their triglyceride-cleaving activities but also in order to generate peracids in situ from suitable precursors. These include, for example, the lipases-obtainable originally from Humicola lanugainosa, (Thermomyces lanuginosus), or further developed lipases, in particular, those having the D96L amino-acid exchange. They are marketed, for example, by Novozymes under the trade names Lipolase®, Lipolase® Ultra, LipoPrime®, Lipozyme®, and Lipex®. The cutinases that were originally isolated from Fusarium solani pisi and Humicola insolens are moreover usable. Usable lipases are likewise obtainable from Amano under the designations Lipase CE®, Lipase P®, Lipase B®, or Lipase CES®, Lipase AKG®, Bacillis sp, Lipase®, Lipase AP®, Lipase M-AP®, and Lipase AML®. The lipases and cutinases from, for example, Genencor, whose starting enzymes were originally isolated from Pseudomonas mendocina and Fusarium solanii, are usable. To be mentioned as further important commercial products are the preparations M1 Lipase® and Lipomax® originally marketed by Gist-Brocades, and the enzymes marketed by Meito-Sangyo KK, Japan, under the names Lipase MY 30®, Lipase OF®, and Lipase PL®, as well as the Lumafast Product of Genencor.

Enzymes that are grouped under the term “hemicellulases” can additionally be used. These include, for example, mannanases, xanthanlyases, pectinlyases (=pectinases, pectinesterases, pectatelyases, xyloglucanases (xylanases), pullulanases, and β-glucanases. Suitable mannanases are obtainable, for example, under the names Gamanase® and Pektinex AR® from Novozymes, under the name Rohapec® B1L from AB Enzymes, and under the name Pyrolase® from Diversa Corp. San Diego, Calif., USA. The β-glucanase obtained from B. subtilis is available under the name Cereflo® from Novozymes.

Oxidoreductases, for example, oxidases, oxygenases, catalases, peroxidases such as halo-, chloro-, bromo-, lignin, glucose, or manganese peroxidases, dioxygenases, or laccases (phenoloxidases, polyphenoloxidases) can be used according to the present invention to enhance the bleaching effect. Suitable commercial products that may be mentioned are Denilite® 1 and 2 of Novozymes. Advantageously, preferably organic, particularly preferably aromatic compounds that interact with the enzymes are additionally added in order to intensify the activity of the relevant oxidoreductases (enhancers) or, if there is a large difference in redox potentials between the oxidizing enzymes and the dirt particles, to ensure electron flow (mediators).

The enzymes derive either originally from microorganisms, for example, the genera Bacillus, Streptomyces, Humicola, or Pseudomonas, and/or are produced by suitable microorganisms in accordance with biotechnological methods known per se, for example, by transgenic expression hosts of Bacillus species or filamentous fungi.

Purification of the relevant enzymes is preferably accomplished by way of methods established per se, for example, by precipitation, sedimentation, concentration, filtration of the liquid phases, microfiltration, ultrafiltration, the action of chemicals, deodorization, or suitable combinations of these steps.

The enzymes can be used in any form established according to the existing art. These include, for example the solid preparations obtained by granulation, extrusion, or lyophilization or, especially in the case of liquid or gelled agents, solutions of the enzymes, advantageously as concentrated as possible, anhydrous, and/or with stabilizers added.

Alternatively, the enzymes can be encapsulated for both the solid and the liquid administration form, for example, by spray-drying or extrusion of the enzyme solution together with a preferably natural polymer, or in the form of capsules, for example, ones in which the enzymes are enclosed e.g., in a solidified gel, or in those of the core-shell type, in which an enzyme-containing core is covered with a protective layer impermeable to water, air, and/or chemicals. Further active substances, for example, stabilizers, emulsifiers, pigments, bleaching agents, or dyes, can additionally be applied in superimposed layers. Such capsules are applied in accordance with methods known per se, for example, by vibratory or rolling granulation or in fluidized-bed processes. Such granules are advantageously low in dust, e.g. as a result of the application of polymer film-forming agents, and are stable in storage thanks to the coating.

It is additionally possible to formulate two or more enzymes together, so that a single granule exhibits several enzyme activities.

A protein and/or enzyme can be protected, especially during storage, from damage such as, for example, inactivation, denaturing, or decomposition, resulting e.g., from physical influences, oxidation, or proteolytic cleavage. An inhibition of proteolysis is particularly preferred in the context of microbial recovery of the proteins and/or enzymes, in particular, when the agents also contain proteases. Washing or cleaning agents can contain stabilizers for this purpose; the provision of such agents represents a preferred embodiment of the present invention.

Reversible protease inhibitors are one group of stabilizers. Benzamidine hydrochloride, borax, boric acids, boronic acids, or their salts or esters are often used, among them chiefly derivatives having aromatic groups, e.g., ortho-substituted, meta-substituted, or para-substituted phenylboronic acids, or their salts or esters. Ovomucoid and leupeptin, among others, may be mentioned as peptide protease inhibitors; an additional option is the creation of fusion proteins from proteases and peptide inhibitors.

Further enzyme stabilizers are aminoalcohols such as mono-, di-, triethanol- and -paropanolamine and mixtures thereof, aliphatic carboxylic acids up to C₁₂ such as succinic acid, other dicarboxylic acids, or salts of the aforesaid acids. End-capped fatty acid amide alkoxylates are also suitable. Certain organic acids used as builders are additionally capable of stabilizing a contained enzyme.

Lower aliphatic alcohols, but principally polyols, for example, glycerol, ethylene glycol, propylene glycol, or sorbitol, are other frequently used enzyme stabilizers. Calcium salts are likewise used, for example, calcium acetate or calcium formate, as well as magnesium salts.

Polyamide oligomers or polymeric compounds such as lignin, water-soluble vinyl copolymers or cellulose ethers, acrylic polymers, and/or polyamides stabilize the enzyme preparation, inter alia, with respect to physical influences or pH fluctuations. Polyamine-N-oxide-containing polymers act as enzyme stabilizers. Other polymeric stabilizers are the linear C₈-C₁₈ polyoxyalkylenes. Alkyl polyglycosides can stabilize the enzymatic components, and even improve their performance. Cross-linked nitrogen-containing compounds likewise function as enzyme stabilizers.

Reducing agents and antioxidants increase the stability of the enzymes with respect to oxidative breakdown. One sulfur-containing reducing agent is, for example, sodium sulfite.

Combinations of stabilizers are preferably used, for example, made up of polyols, boric acid and/or borax, the combination of boric acid or borate, reducing salts, and succinic acid or other dicarboxylic acids, or the combination of boric acid or borate with polyols or polyamino compounds and with reducing salts. The effect of peptide aldehyde stabilizers is enhanced by the combination with boric acid and/or boric acid derivatives and polyols, and further intensified by the additional use of divalent cations, for example, calcium ions.

Preferably one or more enzymes and/or enzyme preparations are used, preferably solid protease preparations and/or amylase preparations, in quantities from 0.1 to 5 wt %, preferably from 0.2 to 4.5 wt %, and in particular, from 0.4 to 4 wt % based in each case on the entire enzyme-containing agent. Glass Corrosion Inhibitors.

Glass corrosion inhibitors prevent the occurrence of clouding, smearing, and scratching of, but also iridescence on, glass surfaces of automatically cleaned glassware. Preferred glass corrosion inhibitors derive from the group of the magnesium and/or zinc salts and/or magnesium and/or zinc complexes.

A preferred class of compounds that can be used in order to prevent glass corrosion is insoluble zinc salts.

Insoluble zinc salts for purposes of this preferred embodiment are zinc salts that possess a solubility of, at maximum, 10 grams of zinc salt per liter of water at 20° C. Examples of insoluble zinc salts that are particularly preferred according to the present invention are zinc silicate, zinc carbonate, zinc oxide, basic zinc carbonate (Zn₂(OH)₂CO₃), zinc hydroxide, zinc oxalate, zinc monophosphate (Zn₃(PO₄)₂), and zinc pyrophosphate (Zn₂(P₂O₇)).

The aforesaid zinc compounds are preferably used in quantities that bring about a zinc ion content in the agents of between 0.02 and 10 wt %, preferably between 0.1 and 5.0 wt %, and in particular, between 0.2 and 1.0 wt %, based in each case on the entire glass corrosion inhibitor-containing agent. The agents' exact content of zinc salt or salts is, of course, dependent on the type of zinc salts; the lower the solubility of the zinc salt used, the higher its concentration should be in the agents.

Because the insoluble zinc salts remain for the most part unchanged during the dishwashing process the particle size of the salts is a criterion requiring care so that the salts do not adhere to glassware or to machine arts. Agents in which the insoluble zinc salts have a particle size below 1.7 millimeters are preferred here.

If the maximum particle size of the insoluble zinc salts is below 1.7 mm, there is no risk of insoluble residues in the automatic dishwasher. In order further to minimize the danger of insoluble residues, the insoluble zinc salt preferably has an average particle size that is well below that value, for example, an average particle size of less than 250 μm. This once again is all the more applicable the lower the solubility of the zinc salt. In addition, the class corrosion-inhibiting effectiveness rises with decreasing particle size. For very poorly soluble zinc salts, the average particle size is preferably below 100 μm. It can be even lower for even more poorly soluble salts; for the very poorly soluble zinc oxide, for example, average particle sizes below 60 μm are preferred.

A further preferred class of compounds is magnesium and/or zinc salt(s) of at least one monomeric and/or polymeric organic acid. The effect of these is that even with repeated use, the surfaces of washed glassware are not modified in corrosive fashion; in particular, no clouding, smearing, or scratching of, but also no iridescence on, the glass surfaces are caused.

Although all magnesium and/or zinc salt(s) of monomeric and/or polymeric organic acids can be used the magnesium and/or zinc salts of monomeric and/or polymeric organic acids from the groups of the unbranched saturated or unsaturated monocarboxylic acids, the branched saturated or unsaturated monocarboxylic acids, the saturated and unsaturated dicarboxylic acids, the aromatic mono-, di- and tricarboxylic acids, the sugar acids, the hydroxy acids, the oxo acids, the amino acids, and/or the polymeric carboxylic acids are nevertheless preferred.

The spectrum of zinc salts of organic acids, preferably of organic carboxylic acids, preferred according to the present invention extends from salts that are poorly soluble or insoluble in water, i.e., exhibit a solubility below 100 mg/L, preferably below 10 mg/L, in particular, below 0.01 mg/L, to those salts that exhibit a solubility in water above 10 mg/L, preferably above 500 mg/L, particularly preferably above 1 g/L, and in particular, above 5 g/L (all solubilities at a 20° C. water temperature). Zinc citrate, zinc oleate, and zinc stearate, for example, belong to the first group of zinc salts; zinc formate, zinc acetate, zinc lactate, and zinc gluconate, for example, belong to the group of the soluble zinc salts.

With particular preference, at least one zinc salt of an organic carboxylic acid, particularly preferably a zinc salt from the group of zinc stearate, zinc oleate, zinc gluconate, zinc acetate, zinc lactate and/or zinc citrate, is used as a glass corrosion inhibitor, Zinc ricinoleate, zinc abietate, and zinc oxalate are also preferred.

In the context of the present invention, the zinc salt concentration of cleaning agents is preferably from 0.1 to 5 wt %, preferably between 0.2 and 4 wt %, and in particular, between 0.4 and 3 wt %, or that of zinc in oxidized for (calculated as Zn²⁺) is between 0.01 and 1 wt %, preferably between 0.02 and 0.5 wt %, and in particular, between 0.04 and 0.2 wt %, base in each case on the total weight of the glass corrosion-inhibiting agent.

### Corrosion Inhibitors.

Corrosion inhibitors serve to protect the items being washed or the machine, silver protection agents having particular importance in the automatic dishwashing sector. The known substances of the existing art are usable. In general, silver protection agents can be selected principally from the group of the triazoles, benzotriazoles, bisbenzotriazoles aminotriazoles, alkylaminotriazoles, and transition-metal salts or complexes. Benzotriazole and/or alkylaminotriazole are particularly preferred for use. The following can be mentioned as examples of the 3-amino-5-alkyl-1,2,4-triazoles preferred for use according to the present invention: propyl-, butyl-, pentyl-, heptyl-, octyl-, nonyl-, decyl-, undecyl-, dodecyl-, isononyl-, versatic-10 acid alkyl-, phenyl-, p-tolyl-, (4-tert, butylphenyl)-, (4-methoxyphenyl)-, (2-, 3-, 4-pyridyl)-, (2-thienyl)-, (5-methyl-2-furyl)-, (5-oxo-2-pyrrolidinyl)-, -3-amino-1,2,4-triazole. In dishwashing agents the alkylamino-1,2,4-triazoles or their physiologically acceptable salts are used at a concentration of 0.001 to 10 wt %, preferably 0.0025 to 2 wt %, particularly preferably 0.01 to 0.04 wt %. Preferred acids for salt formation are hydrochloric-acid, sulfuric acid, phosphoric acid, carbonic acid, sulfurous acid, organic carboxylic acids such as acetic, glycolic, citric, succinic acid, 5-pentyl, 5-heptyl, 5-nonyl, 5-undecyl, 5-isononyl, 5-versatic-10-acid alkyl-3-amino-1,2,4-triazoles, and mixtures of these substances, are very particularly effective.

Cleaner formulations moreover often comprise agents containing active chlorine, which agents can greatly decrease the corrosion of silver surfaces. In chlorine-free cleaners, oxygen- and nitrogen-containing organic redox-active compounds are used in particular, such as di- and trivalent phenols e.g., hydroquinone, catechol, hydroxyhydroquinone, gallic acid, phloroglucine, pyrogallol, and derivatives of these classes of compounds. Salt-like and complex-like inorganic compounds, for example, salts of the metals Mn, Ti, Zr, Hf, V, Co, and Ce, are also often used. Preferred in this context are the transition-metal salts that are selected from the group of the manganese and/or cobalt salts and/or complexes, particularly preferably the cobalt(ammine) complexes, cobalt(acetate) complexes, cobalt(carbonyl) complexes, the chlorides of cobalt or manganese, and manganese sulfate. Zinc compounds can also be used to prevent corrosion of the items being washed.

Instead of or in addition to the silver protection agents described above, for example, the benzotriazoles, redox-active substances can be used. These substances are preferably inorganic redox-active substances from the group of the manganese, titanium, zirconium, hafnium, vanadium, cobalt, and cerium salts and/or complexes, the metals preferably being present in one of the oxidation stages II, III, IV, V, or VI.

The metal salts or metal complexes that are used should be at least partially soluble in water. The counterions suitable for salt formation comprise all usual singly, doubly, or triply negatively charged inorganic anions. e.g., oxide, sulfate, nitrate, fluoride, but also organic anions such as, for example, stearate.

Metal complexes for purposes of the invention are compounds that comprise a central atom and one or more ligands, as well as, if applicable, additionally one or more of the aforementioned anions. The central atom is one of the aforementioned metals in one of the aforementioned oxidation stages. The ligands are neutral molecules or anions that are unidentate or multidentate; the term “ligand” for purposes of the invention is explained in more detail in, for example, “Römpp Chemie Lexikon,” Georg Thieme Verlag Stuttgart/New York, 9th edition 1990, page 2507. If the charge of the central atom and the charge of the ligand(s) in a metal complex do not add up to zero, charge equalization is ensured by either one or more of the aforementioned anions or one or more cations e.g., sodium, potassium, ammonium ions, depending on whether a cationic or anionic charge excess exists. Suitable complexing agents are, for example, citrate, acetyl acetonate, or 1-hydroxyethane-1,1-diphosphonate.

The definition of “oxidation stage” commonly used in chemistry is provided, for example, in “Römpp Chemie Lexikon,” Georg Thieme Verlag Stuttgart/New York, 9th edition, 1991, page 3168.

Particularly preferred metal salts and/or metal complexes are selected from the group of MnSO₄, Mn(II) citrate, Mn(II) stearate, Mn(II) acetyl acetonate, Mn(II)-[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ and mixtures thereof, so that the metal salts and/or metal complexes selected from the group of MnSO₄, Mn(II) citrate, Mn(II) stearate, Mn(II) acetyl acetonate, Mn(II) [1-hydroxyethane-1,1-diphosphonate], V₂O, V₂O₄, VO₂, TiOSO₄, K₂TiF₆, K₂ZrF₆, CoSO₄, Co(NO₃)₂, Ce(NO₃)₃ are used with particular preference.

These metal salts or metal complexes are, in general, commercially available substances that can be used without prior purification in washing and cleaning agents for purposes of silver corrosion protection. For example, the mixture of pentavalent and tetravalent vanadium (V₂O₅, VO₂, V₂O₄) known from SO₃ production (contact method) is suitable, as is the titanyl sulfate TiOSO₄ resulting from dilution of a Ti(SO₄)₂ solution.

The inorganic redox-active substances, in particular, metal salts or metal complexes, are preferably coated, i.e., completely covered with a material that is watertight but easily soluble at cleaning temperatures, in order to prevent their premature decomposition or oxidation during storage. Preferred coating materials, which are applied using known methods, e.g. Sandwik melt-coating methods from the food industry, are paraffins, microcrystalline waxes, waxes of natural origin such as carnauba wax, candelilla wax, beeswax, higher-melting-point alcohols such as, for example, hexadecanol, soaps, or fatty acids. The coating material, which is solid at room temperature, is applied in the molten state onto the material to be coated, for example, by shooting fine particles of material to be coated, in a continuous stream, through a likewise continuously generated spray-mist zone of the molten coating material. The melting point must be selected so that the coating material does not easily dissolve or rapidly melt during silver treatment. The melting point should ideally be in the range between 45° C. and 65° C., and preferably in the range 50° C. to 60° C.

The aforesaid metal salts and/or metal complexes are contained in cleaning agents preferably in a quantity from 0.05 to 6 wt %, preferably 0.2 to 2.5 wt %, based in each case on the entire corrosion inhibitor-containing agent.

### Disintegration Adjuvants.

In order to facilitate the breakdown of prefabricated shaped elements, it is possible to incorporate disintegration adjuvants, so-called tablet bursting agents, into those agents in order to shorten breakdown times. Tablet bursting agents or breakdown accelerators are understood, in accordance with Römpp (9th ed., Vol. 6, p. 4440) and Voigt “Lehrbuch der pharmazeutischen Technologie” [Textbook of pharmaceutical technology] (6th ed., 1987, pp. 182-184) as adjuvants that ensure the rapid breakdown of tablets in water or gastric juice, and the release of drugs in resorbable form.

These substances, which are also referred to as “bursting” agents because of their action, increase in volume upon the entry of water; on the one hand, their own volume is increased (swelling), and on the other hand the release of gases can also generate a pressure that allows the tablets to break down into smaller particles. Familiar disintegration adjuvants are, for example, carbonate/citric acid systems; other organic acids can also be used. Swelling disintegration adjuvants are, for example, synthetic polymers such as polyvinylpyrrolidone (PVP), or natural polymers or modified natural substances such as cellulose and starch and their derivates, alginates, or casein derivatives.

Disintegration adjuvants are used by preference in quantities from 0.5 to 10 wt %, preferably 3 to 7 wt %, and in particular, 4 to 6 wt %, based in each case on the total weight of the disintegration adjuvant-containing agent.

Cellulose-based disintegration agents are used as preferred disintegration agents in the context of the present invention, so that preferred washing and cleaning agents contain such a cellulose-based disintegration agent in quantities from 0.5 to 10 wt %, preferably 3 to 7 wt %, and in particular, 4 to 6 wt %. Pure cellulose has the formal gross composition (C₆H₁₀O₆)ₙ, and in formal terms constitutes a β-1,4-polyacetal of cellobiose, which in turn is made up of two molecules of glucose. Suitable celluloses comprise approximately 500 to 5,000 glucose units, and consequently have average molar weights from 50,000 to 500,000. Also usable in the context of the present invention as cellulose-based disintegration agents are cellulose derivatives that are obtainable from cellulose via polymer-analogous reactions. Such chemically modified celluloses encompass, for example, products of esterification or etherification processes in which hydroxy hydrogen atoms were substituted. Celluloses in which the hydroxy groups were replaced with functional groups that are not bound via an oxygen atom can also, however, be used as cellulose derivatives. The group of the cellulose derivatives embraces, for example, alkali celluloses, carboxymethyl cellulose (CMC), cellulose esters and ethers, and aminocelluloses. The aforesaid cellulose derivatives are preferably not used as the only cellulose-based disintegration agent, but are utilized mixed with cellulose. The cellulose-derivative content of these mixtures is preferably below 50 wt %, particularly preferably below 20 wt %, based on the cellulose-based disintegration agent. Pure cellulose that is free of cellulose derivatives is particularly preferred for use as a cellulose-based disintegration agent.

The cellulose used as a disintegration adjuvant is preferably used not in finely divided form, but instead is converted into a coarser form, for example, granulated or compacted, before being mixed into the premixtures that are to be compressed. The particle sizes of such disintegration agents are usually above 200 μm, preferably at least 90 wt % between 300 and 1,600 μm, and in particular, at least 90 wt % between 400 and 1,200 μm. The aforesaid coarser cellulose-based disintegration adjuvants mentioned above and described in more detail in the referenced documents are preferred for use as disintegration adjuvants in the context of the present invention, and obtainable commercially, for example, from the Rettenmaier company under the designation Arbocel® TF-30-HG.

Microcrystalline cellulose can be used as a further cellulose-based disintegration agent or as a constituent of that component. This microcrystalline cellulose is obtained by partial hydrolysis of celluloses under conditions such that only the amorphous regions (approximately 30% of the total cellulose mass) of the celluloses are attacked and dissolve completely, but the crystalline regions (approximately 70%) remain undamaged. A subsequent disaggregation of the microfine celluloses produced by hydrolysis yields the microcrystalline celluloses, which have primary particle sizes of approximately 5 μm and are compactable, for example, into granules having an average particle size of 200 μm.

Preferred disintegration adjuvants, preferably a cellulose-based disintegration adjuvant, preferably in granular, co-granulated, or compacted form, are contained in the disintegration agent-containing agents in quantities from 0.5 to 10 wt %, preferably from 3 to 7 wt %, and in particular, from 4 to 6 wt %, based in each case on the total weight of the disintegration agent-containing agent.

Gas-evolving effervescence systems can furthermore be additionally used in preferred fashion according to the present invention. The gas-evolving effervescence system can be made up of a single substance that releases a gas upon contact with water. To be mentioned among these compounds is, in particular, magnesium peroxide, which releases oxygen upon contact with water. Usually, however, the gas-releasing bubbling system is in turn made up of at least two constituents that react with one another to form gas. While a plurality of systems that release, for example, nitrogen, oxygen, or hydrogen are conceivable and implementable here, the bubbling system used in the washing and cleaning agents will be selected with regard to both economic and environmental considerations. Preferred effervescence systems comprise alkali-metal carbonate and/or hydrogencarbonate as well as an acidifying agent that is suitable for releasing carbon dioxide from the alkali-metal salts in aqueous solution.

Among the alkali-metal carbonates or hydrogencarbonates, the sodium and potassium salts are greatly preferred over the other salts for cost reasons. It is of course not necessary for the relevant pure alkali-metal carbonates or hydrogencarbonates to be used; mixtures of different carbonates and hydrogencarbonates can instead be preferred.

Preferably 2 to 20 wt %, by preference 3 to 15 wt %, and in particular, 5 to 10 wt % of an alkali-metal carbonate or hydrogencarbonate, as well as 1 to 15, preferably 2 to 12, and in particular, 3 to 10 wt % of an acidifying agent, based in each case on the total weight of the agent, are used as an effervescence system.

Boric acid, as well as alkali-metal hydrogensulfates, alkali-metal dihydrogenphosphates, and other inorganic salts are usable, for example, as acidifying agents that release carbon dioxide from the alkali salts in aqueous solution. Organic acidifying agents are preferably used, however, citric acid being a particularly preferred acidifying agent. Also usable in particular, however, are the other solid mono-, oligo-, and polycarboxylic acids. Of this group, tartaric acid, succinic acid, malonic acid, adipic acid, maleic acid, fumaric acid, oxalic acid, and polyacrylic acid are in turn preferred. Organic sulfonic acids such as amidosulfonic add are likewise usable. Sokalan® DCS (trademark of BASF), a mixture of succinic acid (max. 31 wt %), glutaric acid (max, 50 wt %) and adipic acid (max. 33 wt %), is commercially obtainable and likewise preferred for use as an acidifying agent in the context of the present invention, Acidifying agents in the effervescence system from the group of the organic di-, tri-, and oligocarboxylic acids, or mixtures, are preferred. Fragrances.

Individual odorant compounds, e.g., the synthetic products of the ester, ether, aldehyde, ketone, alcohol, and hydrocarbon types, can be used in the context of the present invention as perfume oils or fragrances. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate) styrallyl propionate, and benzyl salicylate. The ethers include, for example, benzylethyl ether; the aldehydes, for example, the linear alkanals having 8-18 C atoms, citral, citronellal, citronellyloxyacetaldehyde) cyclamenaldehyde, hydroxycitronellal, filial and bourgeonal; the ketones, for example, the ionones, α-isomethylionone and methylcedryl ketone; the alcohols, anethol, citronellol, eugenol, geraniol, linalool, phenylethyl alcohol and terpineol; and the hydrocarbons include chiefly the terpenes such as limonene and pinene. Preferably, however, mixtures of different odorants that together produce an attractive fragrance note are used. Such perfume oils can also contain natural odorant mixtures, such as those accessible from plant sources, for example, pine, citrus, jasmine, patchouti, rose, or ylang-ylang oil. Also suitable are muscatel, salvia oil, chamomile oil, clove oil, lemon balm oil, mint oil, cinnamon leaf oil, linden blossom oil, juniper berry oil, vetiver oil, olibanum oil, galbanum oil, and labdanum oil, as well as orange blossom oil, neroli oil, orange peel oil, and sandalwood oil.

The general description of the usable perfumes (see above) represents in general the different substance classes of odorants. To be perceptible, an odorant must be volatile; in addition to the nature of the functional groups and the structure of the chemical compound, the molecular weight also plays an important part. Most odorants, for example, possess molecular weights of up to approximately 200 dalton, white molecular weights of 300 dalton and above represent something of an exception. Because of the differing volatility of odorants, the odor of a perfume or fragrance made up of multiple odorants changes during volatilization, the odor impressions being subdivided into a “top note” “middle note” or “body,” and “end note” or “dry out” Because the perception of an odor also depends a great deal on the odor intensity, the top note of a perfume or fragrance is not made up only of highly volatile compounds, while the end note comprises for the most part less-volatile, i.e., adherent odorants. In the compounding of perfumes, more-volatile odorants can, for example, be bound to specific fixatives, thereby preventing them from volatilizing too quickly. In the division below of odorants into “more-volatile” and “adherent” odorants, no statement is made with regard to the odor impression, or as to whether the corresponding odorant is perceived as a top or middle note.

Adherent odorants that are usable in the context of the present invention are, for example, the essential oils such as angelica oil, anise oil, arnica flower oil, basil oil, bay oil, bergamot oil, champaca flower oil, silver fir oil, silver fir cone oil, elemi oil, eucalyptus oil, fennel oil, fir needle oil, galbanum oil, geranium oil, gingergrass oil, guaiac wood oil, balsam gudun oil, helichrysum oil, ho oil, ginger oil, iris oil, cajeput oil, calamus oil, chamomile oil, camphor oil, kanaga oil, cardamom oil, cassia oil, pine needle oil, balsam copaiva oil, coriander oil, curled peppermint oil, caraway oil, cumin oil, lavender oil, lemon grass oil, lime oil, tangerine oil, lemon balm oil, ambrette seed oil, myrrh oil, clove oil, neroli oil, niaouli oil, olibanum oil, orange oil, oregano oil, palmarosa oil, patchouli oil, balsam peru oil, petitgrain oil, pepper oil, peppermint oil, pimento oil, pine oil, rose oil, rosemary oil, sandalwood oil, celery oil, spik oil, star anise oil, turpentine oil, thuja oil, thyme oil, verbena oil, vetiver oil, juniper berry oil, wormwood oil, wintergreen oil, ylang-ylang oil, ysop oil, cinnamon oil, cinnamon leaf oil, citronella oil, lemon oil and cypress oil. The higher-boiling or solid odorants of natural or synthetic origin can, however, also be used in the context of the present invention as adherent odorants or odorant mixtures, i.e., fragrances. These compounds include the compounds recited below and mixtures thereof: ambrettolide, α-amylcinnarnaldehyd, anethole, anisealdehyde, anise alcohol, anisole, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerate, borneol, bornyl acetate, a-bromostyrene, n-decylaidehyde, n-dodecylaldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaidehyde, hydroxycinnamnl alcohol, indole, irone, isoeugenol, isoeugenol methyl ether, isosafrol, jasmone, camphor, carvacrol, carvone, p-cresol methyl ether, cumarin, p-methoxyacetophenone, methyl-n-amylketone, methylanthranilic acid methyl ester, p-methylacetophenone, methylchavicol, p-methylquinoline, methyl-β-naphthylketone, methyl-n-nonylacetaldehyde, methyl-n-nonylketone, muscone, β-naphthol ethyl ether, β-naphthol methyl ether, nerol, nitrobenzene, n-nonylaldehyde, nonyl alcohol, n-octylaldehyde, p-oxyacetophenone, pentadecanolide, β-phenylethyl alcohol, phenylacetaldehyde dimethyl acetal, phenylacetic acid, pulegone, safole, salicylic acid isoamyl ester, salicylic acid methyl ester, salicylic acid hexyl ester, salicylic acid cyclohexyl ester, santalol, skatole, terpineol, thymene, thymol, γ-undelactone, vanillin, veratrumaldehyde, cinnamaldehyde, cinnamyl alcohol, cinnamic acid, cinnamic acid ethyl ester, cinnamic acid benzyl ester. Included among the more-volatile odorants are, in particular, the lower-boiling odorants of natural or synthetic origin that can be used alone or in mixtures. Examples of more-volatile odorants are alkylsothiocyanates (alkylmustard oils), butanedione, limonene, linalool, linalyl acetate and propionate, menthol, mennthone, methyl-n-heptenone, phellandrene, phenylacetaldehyde, terpinyl acetate, citral, citronellal.

The fragrances can be processed directly, but it may also be advantageous to apply the fragrances onto carriers that ensure a slower fragrance release for longer-lasting fragrance. Cyclodextrins, for example, have proven successful as carrier materials of this kind; the cyclodextrin-perfume complexes can additionally be coated with further adjuvants.

### Dyes.

Preferred dyes, the selection of which will present no difficulty whatsoever to one skilled in the art, possess excellent shelf stability and insensitivity to the other ingredients of the agents and to light, and no pronounced substantivity with respect to the substrates to be treated with the dye-containing agents, such as textiles glass, ceramics, or plastic dishes, in order not to color them.

In selecting the coloring agent care must be taken that the coloring agents do not exhibit too great an affinity for textile surfaces, and here in particular, with respect to synthetic fibers, while in the case of cleaning agents, an excessive affinity with respect to glass, ceramic, or plastic dishes must be avoided. At the same time, it must also be considered when selecting suitable coloring agents that coloring agents have differing levels of stability with respect to oxidation. It is generally the case that water-insoluble coloring agents are more stable with respect to oxidation than water-soluble coloring agents. The concentration of the coloring agent in the washing or cleaning agents varies as a function of solubility and thus also of oxidation sensitivity. For readily water-soluble coloring agents, e.g., the aforementioned Basacid® Green or (likewise aforementioned) Sandolan® Blue, coloring-agent concentrations in the range of a few 10⁻² to 10⁻³ wt % are typically selected. In the case of the pigment dyes, on the other hand, which are particularly preferred because of their brilliance but are less readily water-soluble, e.g., the aforementioned Pigmosol® dyes, the appropriate concentration of the coloring agent in the washing or cleaning agent is typically a few 101 to 10⁻⁴ wt %.

Coloring agents that can be oxidatively destroyed in the cleaning process, as well as mixtures thereof with suitable blue dyes, so-called bluing agents, are preferred. It has proven advantageous to use coloring agents that are soluble in water or at room temperature in liquid organic substances. Anionic coloring agents, e.g., anionic nitroso dyes, are suitable, for example. One possible coloring agent is, for example, naphthol green (Color Index (CI) Part 1: Acid Green 1, Part 2: 10020), which is available as a commercial product, for example, as Basacid® Green 970 of BASF, Ludwigshafen, as well as mixtures thereof with suitable blue dyes. Pigmosol® Blue 6900 (CI 74160), Pigmosol® Green 8730 (CI 74260), Basonyl® Red 545 FL (CI 45170), Sandolan® Rhodamine EB400 (CI 45100), Basacid® Yellow 094 (CI 47005), Sicovit® Patent Blue 85 E 131 (CI 42051), Acid Blue 183 (CAS 12217-22-0, CI Acidblue 183), Pigment Blue 15 (CI 74160), Supranol® Blue GLW (CAS 12219-32-8, CI Acidblue 221), Nylosan® Yellow N-7GL SGR (GAS 61814-57-1, CI Acidyellow 218) and/or Sandolan® Blue (Cl Acid Blue 182, CAS 12219-26-0) are used as further coloring agents.

In addition to the components previously described in detail, the washing and cleaning agents can contain further ingredients that further improve the application-engineering and/or aesthetic properties of said agents. Preferred agents contain one or more substances from the group of the electrolytes, pH adjusting agents, fluorescence agents, hydrotopes, foam inhibitors, silicone oils, antiredeposition agents, optical brighteners, graying inhibitors, shrinkage preventers, crease-prevention agents, color transfer inhibitors, antimicrobial active substances, germicides, fungicides, antioxidants, antistatic agents, ironing adjuvants, proofing and impregnating agents, swelling and anti-slip agents, and UV absorbers.

A large number of very varied salts from the group of the inorganic salts can be used as electrolytes. Preferred cations are the alkali and alkaline-earth metals; preferred anions are the halides and sulfides. From a production-engineering standpoint, the use of NaCl or MgCl₂ in the washing or cleaning agents is preferred.

The use of pH-adjusting agents may be indicated in order to bring the pH of washing or cleaning agents into the desired range. All known acids and bases are usable here, provide their use is not prohibited for applications-engineering reasons or in the interest of user safety. The quantity of such adjusting agents usually does not exceed 1 wt % of the entire formulation. Appropriate foam inhibitors are, among others, soaps, oils, fats, paraffins, or silicone oils, which optionally can be applied onto carrier materials. Suitable carrier materials are, for example, inorganic salts such as carbonates or sulfates, cellulose derivatives, or silicates, as well as mixtures of the aforesaid materials Agents preferred in the context of the present application contain paraffins, preferably unbranched paraffins (n-paraffins), and/or silicones, preferably linear polymeric silicones, which are constructed according to the (R₂SiO)ₓ pattern and are also referred to as silicone oils. These silicone oils usually represent clear, colorless, neutral, odorless, hydrophobic liquids having a molecular weight between 1,000 and 150,000 and viscosities between 10 and 1,000,000 mPa·s.

Suitable anti-redeposition agents (also referred to as soil repellents) are, for example, nonionic cellulose ethers such as methyl cellulose and methylhydroxypropyl cellulose having a 15 to 30 wt % concentration of methoxy groups and a 1 to 15 wt % concentration of hydroxypropyl groups, based in each case on the nonionic cellulose ethers, as well as the polymers, known from the existing art, of phthalic acid and/or terephthalic acid or of their derivatives, in particular, polymers of ethylene terephthalates and/or polyethylene glycol terephthalates or anionically and/or nonionically modified derivatives thereof. Of these, the sulfonated derivatives of the phthalic acid and terephthalic acid polymers are particularly preferred.

Optical brighteners (so-called “whiteners”) can be added to the washing or cleaning agents in order to eliminate graying and yellowing of the treated textiles. These substances are absorbed onto the fibers and cause a brightening and simulated bleaching effect by converting invisible ultraviolet radiation into visible longer-wave light; the ultraviolet light absorbed from sunlight is radiated as a weakly bluish fluorescence, combining with the yellow tint of the grayed or yellowed laundry to yield pure white. Suitable compounds derive, for example, from the substance classes of the 4,4′-diamino-2,2′-stilbenedisulfonic acids (flavonic acids), 4,4′-distyrylbiphenylene, methylumbelliferones, cumarins, dihydroquinolinones, 1,3-diarylpyrazolines, naphthalic acid imides, benzoxazole, benzisoxazole, and benzimidazole systems, and the pyrene derivatives substituted with heterocycles.

The purpose of graying inhibitors is to keep dirt released from the fibers suspended in the bath, thus preventing the dirt from redepositing. Water-soluble colloids, usually organic in nature, are suitable for this, for example, the water-soluble salts of polymeric carboxylic acids, size, gelatin, salts of ethersulfonic acids of starch or cellulose, or salts of acid sulfuric acid esters of cellulose or starch, Water-soluble polyamides containing acid groups are also suitable for this purpose. Soluble starch preparations, and starch products other than those mentioned above, can also be used, e.g., degraded starch, aldehyde starches, etc. Polyvinylpyrrolidone is also usable. Also usable as graying inhibitors are cellulose ethers such as carboxymethyl cellulose (Na salt), methyl cellulose, hydroxyalkyl cellulose, and mixed ethers such as methylhydroxyethyl cellulose, methylhydroxypropyl cellulose, methylcarboxylmethyl cellulose, and mixtures thereof.

Because textile fabrics, in particular, those made of rayon, viscose, cotton, and mixtures thereof, can tend to wrinkle because the individual fibers are sensitive to bending, kinking, compression, and squeezing transversely to the fiber direction, synthetic crease-prevention agents can be used. These include for example, synthetic products based on fatty acids, fatty acid esters, fatty acid amides, fatty acid alkylol esters, fatty acid alkylolamides, or fatty alcohols that are usually reacted with ethylene oxide, or products based on lecithin or modified phosphoric acid esters.

The purpose of proofing and impregnation methods is to finish textiles with substances that prevent the deposition of dirt or make it easier to wash out. Preferred proofing and impregnation agents are perfluorinated fatty acids, including in the form of their aluminum and zirconium salts, organic silicates, silicones, polyacrylic acid esters having perfluorinated alcohol components, or polymerizable compounds coupled to a perfluorinated acyl or sulfonyl radical. Antistatic agents can also be present. Dirt-repelling finishing with proofing and impregnation agents is often categorized as an “easy-care” finish. Penetration of the impregnation agents, in the form of solutions or emulsions of the relevant active substances, can be facilitated by the addition of wetting agents that reduce surface tension. A further area of use of proofing and impregnation agents is water-repellent finishing of textile materials, tents, awnings, leather, etc. in which, in contrast to waterproofing, the fabric pores are not sealed, i.e., the material is still able to “breathe” (hydrophobizing). The hydrophobizing agents used for hydrophobizing cover the textiles, leather, paper, wood, etc. with a very thin layer of hydrophobic groups such as longer alkyl chains or siloxane groups. Suitable hydrophobizing agents are, for example, paraffins, waxes, metal soaps, etc. having added portions of aluminum or zirconium salts, quaternary ammonium compounds with long-chain alkyl radicals, urea derivatives, fatty acid-modified melamrine resins, chromiurncomplex salts, silicones, organo-tin compounds, and glutaric dialdehyde, as well as perfluorinated compounds. The hydrophobized materials are not oily to the touch, but water droplets bead up on them (similarly to oiled fabrics) without wetting them. Silicone-impregnated textiles, for example, have a soft hand and are water- and dirt-repellent; drops of ink, wine, fruit juice, and the like are easier to remove.

To counteract microorganisms, antimicrobial active substances can be used. A distinction is made here, in terms of the antimicrobial spectrum and mechanism of action, between bacteriostatics and bactericides, fungistatics and fungicides, etc. Important substances from these groups are, for example, benzalkonium chlorides, alkylarylsulfonates, halogen phenols, and phenol mercuric acetate; these compounds can also be entirely omitted.

The washing and cleaning agents can contain antioxidants in order to prevent undesired changes, caused by the action of oxygen and other oxidative processes, to the agents and/or to the treated textiles. This class of compounds includes, for example, substituted phenols, hydroquinones, catechols, and aromatic amines, as well as organic sulfides, polysulfides, dithiocarbamates, phosphites, and phosphonates.

Increased wearing comfort can result from the additional use of antistatic agents. Antistatic agents increase the surface conductivity and thus make possible improved dissipation of charges that have formed. External antistatic agents are usually substances having at least one hydrophilic molecule ligand, and form a more or less hygroscopic film on the surfaces. These usually surface-active antistatic agents can be subdivided into nitrogen-containing (amines, amides, quaternary ammonium compounds), phosphorus-containing (phosphoric acid esters), and sulfur-containing antistatic agents (alkylsulfonates, alkyl sulfates). Lauryl (or stearyl) dimethylbenzylammonium chlorides are likewise suitable as antistatic agents for textiles or as an additive to washing agents, an avivage effect additionally being achieved.

For textile care and in order to improve textile properties, such as a softer “hand” (avivage) and decreased electrostatic charge (increased wearing comfort), conditioners can be used. The active substances in conditioner formulations are “esterquats,” quaternary ammonium compounds having two hydrophobic radicals such as, for example, distearyldimethylammonium chloride, although because of its insufficient biodegradability the latter is increasingly being replaced by quaternary ammonium compounds that contain ester groups in their hydrophobic radicals as defined break points for biodegradation.

“Esterquats” of this kind having improved biodegradability are obtainable, for example, by esterifying mixtures of methyl diethanolamine and/or triethanolamine with fatty acids, and then quaternizing the reaction products, in a manner known per se, with alkylating agents. Dimethylol ethylene urea is additionally suitable as an appret.

In order to improve the water absorption capability and rewettability of the treated textiles and to facilitate ironing of the treated textiles, silicone derivatives, for example, can be used. These additionally improve the rinsing behavior of the washing or cleaning agents as a result of their foam-inhibiting properties. Preferred silicone derivatives are, for example, polydialkyl or alklarylsitoxanes in which the alkyl groups have one to five C atoms and are entirely or partly fluorinated. Preferred silicones are polydimethylsiloxanes, which optionally can be derivatized and are then aminofunctional or quaternized or have Si—OH, Si—H, and/or Si—Cl bonds. Additional preferred silicones are the polyalkylene oxide-modified polysiloxanes, i.e., polysiloxanes that comprise, for example, polyethylene glycols, as well as the polyalkylene oxide-modified dimethylpolysiloxanes.

Lastly, UV absorbers that are absorbed onto the treated textiles and improve the light-fastness of the fibers can also be used according to the present invention. Compounds that exhibit these desired properties are, for example, the compounds that act by radiationless deactivation, and derivatives of benzophenone having substituents in the 2- and/or 4-position. Also suitable are substituted benzotriazoles, acrylates phenyl-substituted in the 3-position (cinnamic acid derivatives) optionally having cyano groups in the 2-position, salicylates, organic Ni complexes, and natural substances such as umbelliferone and endogenous urocanic acid.

Because of their fiber-care-providing action, protein hydrolysates are further active substances from the field of the washing and cleaning agents that are preferred in the context of the present invention. Protein hydrolysates are product mixtures obtained by the acid-, base-, or enzyme-catalyzed breakdown of proteins. Protein hydrolysates of both plant and animal origin can be used according to the present invention. Animal protein hydrolysates are, for example, elastin, collagen, keratin, silk, and milk protein hydrolysates, which can also be present in the form of salts. The use of protein hydrolysates of plant origin, e.g., soy-, almond-, bean-, potato, and wheat-protein hydrolysates, is preferred according to the present invention. Although the use of protein hydrolysates as such is preferred, it is also optionally possible to use, instead of them, amino-acid mixtures, or individual amino adds such as, for example, arginine, lysine, histidine, or pyrroglutamic acid, obtained in different fashion. It is likewise possible to use derivatives of protein hydrolysates, for example, in the form of their fatty add condensation products.

The nonaqueous solvents that can be used according to the present invention include in particular, the organic solvents, of which only the most important can be listed here; alcohols (methanol, ethanol, propanols, butanols, octanols, cyclohexanol), glycols (ethylene glycol, diethylene glycol), ethers and glycol ethers (diethyl ether, dibutyl ether, anisole, dioxane, tetrahydrofuran, mono-, di-, tri-, polyethylene glycol ethers), ketones (acetone, butanone, cyclohexanone), esters (acetic acid esters, glycol esters), amides and other nitrogen compounds (dimethylformamide, pyridine, N-methylpyrrolidone, acetonitrile), sulfur compounds (carbon disulfide, dimethylsulfoxide, sulfolane), nitrogen compounds (nitrobenzene), halogenated hydrocarbons (dichloromethane, chloroform, tetrachloromethane, tri-, tetrachloroethene 1,2-dichloroethane, chlorofluorocarbons), hydrocarbons (naphthas, petroleum ether, cyclohexane, methylcyclohexane, decalin, terpene solvents, benzene, toluene, xylenes). Alternatively, instead of the pure solvents, it is also possible to use mixtures thereof that, for example, advantageously combine the dissolution properties of different solvents. One such solvent mixture that is particularly preferred in the context of the present application is, for example, white gas, a mixture of different hydrocarbons suitable for chemical cleaning, preferably having a concentration of C₁₂ to C₁₄ hydrocarbons above 60 wt %, particularly preferably above 80 wt %, and in particular, above 90 wt %, based in each case on the total weight of the mixtures, preferably having a boiling range from 81 to 110° C.

1. A method for manufacturing a washing- or cleaning-agent shaped element, comprising the steps of;
a) making available a shaped element that comprises a cavity in the form of a recess or a pass-through hole; and
b) applying a coating agent onto the surface of the shaped element so that the surface coverage of the coated shaped element surface with the coating agent is between 0.2 to 50 mg/cm².

2. The method according to claim 1, wherein the surface coverage of the shaped element is between 0.4 and 40 mg/cm².

3. The method according to claim 1, wherein the coating agent is applied in the form of a solution or dispersion.

4. The method according to claim 1, wherein a water-soluble organic polymer is used as the coating agent.

5. The method according to claim 4, wherein the coating agent is a polymer selected from the group consisting of poly(vinyl)alcohol, polyvinyl pyrrolidone and cellulose ethers.

6. The method according to claim 1, wherein the coating agent is sprayed onto the shaped element.

7. The method according to claim 6, wherein the coating agent is applied onto the shaped element through several separate steps of spraying a solution or dispersion of the coating agent onto the element.

8. The method according to claim 7, wherein the coating agent is applied only to the external surfaces of the shaped element.

9. The method according to claim 7, wherein the cavity is filled before or after application of the coating agent.

10. The method according to claim 1, wherein the coating step is followed by a step of applying a water-soluble or water-dispersible film onto the coating surface of the shaped element.

11. The method according to claim 10, wherein the applying is carried out by heat-sealing the water-soluble or water-dispersible film onto the coated surface of the shaped element.

12. A coated washing- or cleaning-agent shaped element, wherein the shaped element comprises a cavity in the form of a recess or a pass-through hole and the surface coverage of the coated shaped-element surface with a coating agent is between 0.2 and 50 mg/cm².

13. A coated washing- or cleaning-agent shaped element according to claim 11, wherein the surface coverage of the coated shaped-element surface with a coating agent is between 1 and 20 mg/cm².

14. The coated washing- or cleaning-agent shaped element according to claim 11, wherein the coating agent is a water-soluble organic polymer.

15. The coated washing- or cleaning-agent shaped element according to claim 13, wherein the coating agent is selected from the group consisting of poly(vinylalcohol) polyvinyl pyrrolidone and cellulose ethers.

16. The coated washing- or cleaning-agent shaped element according to claim 11 wherein the coated shaped element has a fracture toughness of above 60 N.

17. The coated washing- or cleaning-agent shaped element according to claim 11, wherein only the external surfaces of the shaped element are coated.

18. The coated washing- or cleaning-agent shaped element according to claim 11, wherein the cavity has a filling.

19. The coated washing- or cleaning-agent shaped element according to claim 11, wherein the shaped element has a coated surface covered by a water-soluble or water-dispersible film, the coating and the water-soluble or water-dispersible film being at least in part fused to one another.

20. A coated washing- or cleaning-agent shaped element, wherein the shaped element comprises a cavity in the form of a recess or pass-through hole and is coated with at least two coating agents, wherein the surface coverage of the coated shaped element surface with the coating agent is between 0.2 and 100 mg/cm².
